(19) United States
(12) Patent Application Publication
(10) Pub. No.: US 2012/0058341 A1
(43) Pub. Date: Mar. 8, 2012

(54) TRANSITION METAL SILICIDE-SI COMPOSITE POWDER AND METHOD OF MANUFACTURING THE SAME, AND CASIY-BASED POWDER FOR MANUFACTURING TRANSITION METAL SILICIDE-SI COMPOSITE POWDER AND METHOD OF MANUFACTURING THE SAME

(75) Inventors: Hiroshi ITAHARA, Aichi-gun (JP); Tetsu OHSUNA, Nisshin-shi (JP); Takahiko ASAOKA, Nagoya-shi (JP); Yasuyoshi SAITO, Toyota-shi (JP); Tetsuro KOBAYASHI, Seto-shi (JP)

(73) Assignee: KABUSHIKI KAISHA TOYOTA CHUO KENKYUSHO, Aichi-Ken (JP)

(21) Appl. No.: 13/205,360

(22) Filed: Aug. 8, 2011

(30) Foreign Application Priority Data
Sep. 3, 2010 (JP) 2010-197988
Apr. 20, 2011 (JP) 2011-094237

(51) Int. Cl. B32B 3/00; B29B 9/12

(52) U.S. Cl. 428/402; 264/5

(57) ABSTRACT

A transition metal silicide-Si composite powder and a method of manufacturing the composite powder are provided, the composite powder containing one or more transition metal elements (M), and having a Si/M ratio (z) of 2.0≦z≦20.0 and a specific surface area of 2.5 m²/g or more. In addition, CaSi_{y}-based powder for manufacturing transition metal silicide-Si composite powder and a method of manufacturing the CaSi_{y}-based powder are provided, the CaSi_{y}-based powder having a Si/Ca ratio (w) of 2.0≦w≦20.0 and containing at least a Ca-silicide phase.

### BACKGROUND OF THE INVENTION

1. Field of the Invention

The present invention relates to transition metal silicide-Si composite powder and a method of manufacturing the composite powder, and to CaSi_{y}-based powder for manufacturing transition metal silicide-Si composite powder and a method of manufacturing the CaSi_{y}-based powder. More specifically, the invention relates to transition metal silicide-Si composite powder usable for an anode material of a Li secondary battery and a method of manufacturing the composite powder, and to CaSi_{y}-based powder for manufacturing transition metal silicide-Si composite powder used for manufacturing the transition metal silicide-Si composite powder, and a method of manufacturing the CaSi_{y}-based powder.

2. Description of Related Art

Transition metal silicide contains a large amount of Si, and therefore the silicide typically has high oxidation resistance or high corrosion resistance. As well known, some transition metal silicide has excellent semiconductor properties or exhibits excellent mechanical properties at high temperature. Accordingly, the transition metal silicide is expected to be used for a thermoelectric material, a heating element, an oxidation resistant coating material, a high-temperature structural material, and semiconductor.

Various proposals have been made on a method of manufacturing the transition metal silicide.

For example, Non-patent Document 1 discloses a method of growing a Mn₁₉Si₃₃ nanowire on a heated substrate by a CVD method using a Mn(CO)₅SiCl₃ complex as a raw material.

Non-patent Document 1 describes:

(1) when the Mn (CO)₅SiCl₃ complex is used as a raw material for manufacturing a Mn-silicide nanowire, vapor-phase transport of Mn and Si may be efficiently performed,

(2) a nanowire or nanoribbon having a length of several to several dozen micrometers and a width of 10 to 100 nm is obtained by the method,

(3) a short (approximately 1 μm) nanorod having a diameter of 10 to 20 nm and a small nanoparticle are obtained in addition to the nanowire and the nanoribbon, and the nanowire, the nanoribbon, and the nanorod are likely to be nucleated from the nanoparticle,

(4) a mean Si atomic composition of 25 analyzed nanowires is 58±11%, and some nanowire substantially includes Si only, and

(5) a crystal phase is identified to be Mn₁₉Si₃₃ for each of three nanowires obtained from one sample.

Patent Documents 1 and 2 disclose techniques where a raw material for MnSi_{1.7} is melted, and a molten liquid of the material is dropped while being concurrently sprayed with a spray medium for rapid cooling, so that powder having a single phase of MnSi_{1.7} is synthesized.

In a typical synthesis process including melting and cooling of a raw material, single-phase MnSi_{1.7} powder is hardly obtained because a mixture is formed in accordance with a Mn—Si phase diagram. Patent Document 2 describes:

(a) a single phase can be obtained by rapid cooling, and

(b) fine particles having an average particle diameter of 9.08 μm (specific surface area of 0.31 m²/g) or an average particle diameter of 10.2 μm (specific surface area of 0.29 m²/g) can be synthesized.

Non-patent Document 2 discloses a method where CaSi₂, while being not transition metal silicide, is electrochemically oxidized to remove Ca intercalated between Si layers.

Non-patent Document 2 describes:

(a) the percentage of Ca removed from CaSi₂ varied from 30 to 50%,

(b) Ca is hardly completely removed from CaSi₂ by the method, and

(c) such difficulty in removing Ca is attributable to the inhomogeneity in the electrochemical oxidation.

Insertion and extraction of Li ions may occur for Si, and therefore Si has been studied for use in an anode material of a Li secondary battery. In the case that Si is used in the anode material of the Li secondary battery, Si is typically fixed to a current collector consisting of nickel or the like because Si has low electrical conductivity. However, the volume change of Si reaches three to four times during insertion/extraction of Li ions, and therefore Si is disadvantageously detached from the current collector after repetition of charge and discharge.

In contrast, transition metal silicide typically has high electrical conductivity. For example, MnSiₓ or FeSiₓ is an electron conductor, which has investigated to be used for thermoelectric materials. It is therefore considered that when the transition metal silicide such as MnSiₓ is compounded with Si, a material, having high electrical conductivity and high Li-ion insertion/extraction ability, is obtained. In addition, it is considered that optimization of morphology of the transition metal silicide such as MnSiₓ and of Si leads to relaxation of such volume change induced by insertion/extraction of Li ions, resulting in improvement in durability.

The method described in Non-patent Document 1 allows synthesis of the Mn-silicide (MnSiₓ) nanowire, but hardly allows synthesis of Mn-silicide particles or synthesis of a composite of MnSiₓ and Si. In addition, the method is unsuitable for mass synthesis while it is suitable for thin film formation.

Each of the methods described in Patent Documents 1 and 2 is a liquid quenching method suitable for mass synthesis of fine particles. In addition, it is conceivable that when a composition of molten metal is adjusted to contain excess Si, a composite of MnSiₓ and Si may be manufactured. However, the methods are limited in attainable minimum particle size.

Furthermore, as a conceivable method of manufacturing the composite of MnSiₓ and Si, a Mn—Si ingot containing excess Si is mechanically milled by a ball mill or the like. However, the method is limited in the attainable minimum particle size. In addition, impurities are inevitably mixed in from balls or a container. Furthermore, the method makes the milled particles amorphous, and hardly generates particles having high crystallinity.

### PATENT DOCUMENTS

[Patent Document 1] Japanese Patent Application Laid-Open No. 2002-332508
[Patent Document 2] Japanese Patent No. 3721557

### NON-PATENT DOCUMENTS

[Non-patent Document 1] J. M. Higgins et al., J. Am. Chem. Soc., 130, pp. 16086-16094 (2008)
[Non-patent Document 2] S. Yamanaka et al., Physica 105B, 230 (1981)

### SUMMARY OF THE INVENTION

An object of the invention is to provide a novel transition metal silicide-Si composite material including a composite of transition metal silicide and Si, which is relatively small in particle size, high in crystallinity, and preferable for an anode material of a Li secondary battery, and provide a method of manufacturing the composite material.

Another object of the invention is to provide CaSi_{y}-based powder for manufacturing transition metal silicide-Si composite powder, allowing manufacturing of the above transition metal silicide-Si composite powder, and a method of manufacturing the CaSi_{y}-based powder.

In order to overcome the above-described problem, transition metal silicide-Si composite powder according to the invention is summarized in that

one or more transition metal elements (M) are contained,

a Si/M ratio (z) satisfies 2.0≦z≦20.0, and

a specific surface area is 2.5 m²/g or more.

CaSi_{y}-based powder for manufacturing transition metal silicide-Si composite powder according to the invention is summarized in that

a Si/Ca ratio (w) satisfies 2.0≦w≦20.0,

at least a Ca-silicide phase is contained, and

when the transition metal element (M) includes Mn only, w=2.0 is excluded.

A method of manufacturing the CaSi_{y}-based powder for manufacturing transition metal silicide-Si composite powder according to the invention is summarized by including

a melting step of mixing a Ca source with a Si source into a Si/Ca ratio (molar ratio) (w) of 2.0≦w≦20.0, and melting the Ca and Si sources, and

a solidification step of solidifying molten material obtained in the melting step to obtain the CaSi_{y}-based powder for manufacturing transition metal silicide-Si composite powder according to the invention.

A method of manufacturing the transition metal silicide-Si composite powder according to the invention is summarized by including

a mixing step of mixing the CaSi_{y}-based powder for manufacturing the transition metal silicide-Si composite powder according to the invention with halide of a transition metal element (M),

a reaction step of heating and cooling a mixture obtained in the mixing step, and

a washing step of washing a reaction product obtained in the reaction step by one or more solvents that may dissolve the halide of the transition metal element (M) and/or Ca-halide so as to remove unreacted halide of the transition metal element (M) and the Ca-halide as a by-product.

In synthesizing CaSi_{y} from the Ca source and the Si source, the Si source is added in the amount higher than the stoichiometric amount necessary for forming layered CaSi₂, resulting in CaSi_{y}-based powder (CaSi_{y}—Si composite powder) including a composite of a Ca-silicide phase and a Si phase. The Si source is added in the amount equal to the stoichiometric amount necessary for forming the layered CaSi₂, resulting in CaSi_{y}-based powder substantially including the Ca-silicide phase only in some cases, or in the CaSi_{y}-based powder including the composite of the Ca-silicide phase and the Si phase in other cases.

Next, the CaSi_{y}-based powder and halide of the transition metal element (II) (for example, Mn-chloride) are mixed in a predetermined ratio and heated at a predetermined temperature, resulting in a reaction product containing transition metal silicide particles, Si-nanosheet or Ca-deficient layered Ca-silicide, and Ca-halide. When an excess amount of halide of the transition metal element (M) is mixed, the reaction product also contains unreacted halide of transition metal element (M)

Since both the Ca-halide and the halide of the transition metal element (M) are soluble in a solvent (for example, ethanol), the reaction product is washed by an appropriate solvent, resulting in the transition metal silicide-Si composite powder.

The obtained transition metal silicide-Si composite powder contains fine transition metal silicide particles formed through a reaction of the CaSi₂ phase with the halide of the transition metal element (M), and contains the Si-nanosheet or Ca-deficient layered Ca-silicide, leading to a large specific surface area. Furthermore, the transition metal silicide-Si composite powder includes transition metal silicide particles (conductive material) having high crystallinity and the Si-nanosheet or Ca-deficient layered Ca-silicide (insertion/extraction body of Li ions), which are compounded with each other in nanometer level, and therefore the composite powder exhibits high charge/discharge capacity when used for an anode material of a Li secondary battery.

### BRIEF DESCRIPTION OF THE DRAWINGS

FIG. 1 is a flowchart showing a synthesis method of a sample;

FIG. 2 is a flowchart showing a preparation procedure and an evaluation procedure of an electrode for evaluating a charge/discharge characteristic;

FIG. 3A is a schematic diagram of the evaluation electrode, and FIG. 3B is a schematic diagram of an evaluation apparatus;

FIG. 4 is a powder XRD pattern of each of CaSi_{y}—Si composite powder (Examples 1 and 2) and CaSi_{y} powder (Comparative example 1);

FIG. 5 is a powder XRD pattern of MnSiₓ-Si composite powder obtained in each of the Examples 1, 2 and the Comparative example 1;

FIGS. 5A to 6D are SEM images of the CaSi_{y}—Si composite powder obtained in the Example 2, where FIG. 6A shows a low-magnification SEM image, FIG. 6B shows a middle-magnification SEM image, and FIGS. 5C and 5D show high-magnification SEM images (two visual fields);

FIGS. 7A to 7C are SEM images of MnSiₓ-Si composite powder obtained in the Example 2, where FIG. 7A shows a low-magnification SEM image, and FIGS. 7B and 7c show high-magnification SEM images (two visual fields);

FIGS. 8A to 8D are TEM images of the MnSiₓ-Si composite powder obtained in the Example 2, where FIG. 8A shows a low-magnification TEM image, FIG. 8B shows a middle-magnification TEM image showing enlargement of a portion A of FIG. 8A, FIG. 8C shows a high-magnification TEM image showing enlargement of a portion B of FIG. 8B, and FIG. 8D shows a low-magnification TEM image of a portion different from that in FIGS. 8A to 8C;

FIG. 9 is a schematic diagram of the MnSiₓ-Si composite powder according to an embodiment of the invention;

FIG. 10 is a graph showing a relationship between a Si/Mn ratio and charge capacity of the MnSiₓ-Si composite powder obtained in each of the Examples 1, 2 and a Comparative example 1;

FIG. 11 is a graph showing a relationship between an applied current value and charge capacity (delithiation amount) of each of the MnSiₓ-Si composite powder obtained in the Example 2 and a carbon anode;

FIG. 12 is a flowchart showing a synthesis method of a sample;

FIG. 13 is a powder XRD pattern of CaSi_{y}—Si composite powder (CaSi_{2.05} Powder: Example 11);

FIG. 14 is a powder XRD pattern of FeSiₓ-Si composite powder obtained in the Example 11;

FIG. 15 is a powder XRD pattern of FeSiₓ-Si composite powder obtained in each of the Examples 12 and 13;

FIG. 16 is a SEM image of the FeSiₓ-Si composite powder obtained in the Example 12;

FIG. 17 is a low-magnification TEM image of the FeSiₓ-Si composite powder obtained in the Example 12 (upper left photograph), a high-magnification TEM image of a region containing a FeSi phase (lower left photograph), and an electron diffraction image of the FeSi phase (right photograph);

FIG. 18 is a low-magnification TEM image of a layered substance contained in the FeSiₓ-Si composite powder obtained in the Example 12 (upper left photograph), a high-magnification TEM image thereof (upper right photograph), an electron diffraction image thereof (lower right photograph), and a schematic diagram of the layered substance (lower left diagram);

FIG. 19 is a TEM image of another layered substance contained in the FeSiₓ-Si composite powder obtained in the Example 12 (left photograph) and an electron diffraction image thereof (right photograph); and

FIG. 20 is a TEM image of still another layered substance contained in the FeSiₓ-Si composite powder obtained in the Example 12.

### DESCRIPTION OF THE PREFERRED EMBODIMENT

Hereinafter, a preferred embodiment of the invention will be described in detail.

### [1. Transition Metal Silicide-Si Composite Powder]

Transition metal silicide-Si composite powder according to an embodiment of the invention is summarized in that

one or more transition metal elements (M) are contained,

a Si/M ratio (z) satisfies 2.05≦z≦20.0, and

a specific surface area is 2.5 m²/g or more.

### [1.1. Transition Metal Element (M)]

Any transition metal element (M), which may form a silicide having rather high electrical conductivity, may be used. The transition metal element (M) may be any of Sc to Zn (first transition metal element), Y to Cd (second transition metal element), La to Au (third transition metal element), or Ac to Rg (fourth transition metal element).

In particular, Mn, Fe, Ni, Co, and Ti are preferable as the transition metal element (M). This is because these transition metal elements (M) may be relatively easily synthesized into a silicide having high electrical conductivity, and are inexpensive compared with other transition metal elements.

The composite powder may contain one of the transition metal elements (M), or may contain two or more of the elements.

[1.2. Si/M ratio]

The Si/M ratio (z) represents a molar ratio of Si to the transition metal element (M) in the entire transition metal silicide-Si composite powder.

An extremely low Si/M ratio results in a decrease in percentage of a Si phase in the composite powder. When the transition metal silicide-Si composite powder according to an embodiment of the invention is used for an anode material of a Li secondary battery, the extremely low Si/M ratio causes reduction in charge/discharge capacity of the composite powder. Accordingly, z needs to be 2.0 or more.

In contrast, an excessively high Si/M ratio results in a decrease in percentage of a transition metal silicide phase in the composite powder. When the transition metal silicide-Si composite powder according to an embodiment of the invention is used for the anode material of the Li secondary battery, the excessively high Si/M ratio causes reduction in electrical conductivity of the composite powder. Accordingly, z needs to be 20.0 or less.

### [1.3. Specific Surface Area]

In the case that the transition metal silicide-Si composite powder according to an embodiment of the invention is used for the anode material of the Li secondary battery, as the particle diameter of the Si phase in the composite powder becomes larger, diffusion of Li becomes rate-determining step, leading to reduction in charge/discharge capacity. Moreover, as the particle diameter of the transition metal silicide phase becomes larger, the contact area between the Si phase and the transition metal silicide phase becomes smaller, making it difficult to form a conduction path, and consequently electrical conductivity of the composite powder is reduced. Accordingly, the particle diameter of the composite powder is preferably smaller. In other words, the specific surface area of the composite powder is preferably larger.

When a method as described later is used, composite powder having a specific surface area of 2.5 m²/g or more is obtained. Furthermore, when a manufacturing condition is optimized in the method, composite powder having a specific surface area of 3.0 m²/g or more, or 5.0 m²/g or more is obtained.

### [1.4. Morphology of Composite Powder]

The transition metal silicide-Si composite powder according to an embodiment of the invention includes a composite containing transition metal silicide particles and Si-nanosheet or Ca-deficient layered Ca-silicide. The composite powder may additionally contain Si particles (coarse Si particles derived from a raw material).

### [1.4.1. Transition Metal Silicide Particles]

In an embodiment of the invention, “transition metal silicide particles” means particles mainly containing a transition metal silicide phase having rather high electrical conductivity. The transition metal silicide phase means a phase of a compound including a transition metal element (M) and Si (MSiₓ). A transition metal silicide particle may contain one transition metal element (M), or may be a solid solution containing two or more transition metal elements (M). Alternatively, the transition metal silicide particle may contain one transition metal silicide phase, or may be a mixture containing two or more transition metal silicide phases.

For example, when the transition metal element (M) is Mn, a Mn-silicide phase having high electrical conductivity specifically includes MnSiₓ (1.71≦x≦1.75) phase (or called “MnSi_{1.73} phase” below) and a MnSi phase.

As described later, since MnSiₓ-Si composite powder according to an embodiment of the invention is synthesized under a condition of excess Si, a Mn-silicide particle typically includes the MnSi_{1.73} phase. However, the Mn-silicide particle may contain another Mn-silicide phase such as MnSi phase depending on manufacturing conditions. In an embodiment of the invention, the Mn-silicide particle may contain the Mn-silicide phase other than the MnSi_{1.73} phase.

Among them, the MnSi_{1.73} phase has a crystal structure where a tetragonal Mn sublattice having a β-Sn structure and a tetragonal Si sublattice having a spiral ladder structure are superposed on each other. A lattice constant c_{Mn} along a c-axis direction of the Mn sublattice and a lattice constant c_{Si} along a c-axis direction of the Si sublattice have a relationship of approximately cₛᵢ≈4c_{Mn}. However, while c_{Mn} is substantially constant, c_{Si} slightly varies depending on difference in arrangement of Si. The number of each sublattice in one unit cell needs to be an integer number to produce a repeating crystallographic unit. The MnSiₓ phase thus includes various compounds having different length along a c-axis direction of a unit cell.

As such MnSi_{1.73} phases, specifically, Mn₄Si₇ (MnSi_{1.75}), Mn₁₁Si₁₉ (MnSi_{1.727}), Mn₁₅S₂₆ (MnSi_{1.733}), Mn₂₇Si₄₇ (MnSi_{1.74}), Mn₇Si₁₂ (MnSi_{1.714}), Mn₁₉Si₃₃(MnSi_{1.737}), and Mn₂₆Si₄₅(MnSi_{1.731}) are known.

The Mn-silicide particle may contain one of the various MnSi_{1.73} phases different in long-period structure along a c-axis direction, or may contain two or more of the phases.

For example, when the transition metal element (M) is Fe, a Fe-silicide phase having high electrical conductivity includes a FeSi phase, a FeSi₂ phase, and a Fe₃Si phase. When FeSiₓ-Si composite powder is synthesized using a method described later, a Fe-silicide particle contains at least one of the Fe-silicide phases. In an embodiment of the invention, the Fe-silicide particle may contain two or more kinds of Fe-silicide phases.

While the transition metal silicide particle preferably includes the transition metal silicide phase only, the particle may contain inevitable impurities. However, impurities (for example, insulators such as Mn-oxide or SiO₂) affecting electrical conductivity of the transition metal silicide particle are preferably small in amount.

Here, “mainly containing the transition metal silicide phase” means that the transition metal silicide phase is 70% or more by volume in one particle. The transition metal silicide phase in one particle is preferably 80% or more by volume, and more preferably 90% or more by volume.

### [1.4.2. Si-Phase-Contained Particle]

Here, “Si-phase-contained particle” means a granular or layered substance mainly containing a Si phase. The Si-phase-contained particle includes a coarse Si particle derived from a starting material and Si-nanosheet or Ca-deficient layered Ca-silicide caused by separation of a Si sheet layer from layered CaSi₂.

### [1.4.2.1. Si Particle]

As described later, when CaSi_{y}-based powder containing excess Si is used as a starting material in synthesis of the transition metal silicide-Si composite powder using the method according to an embodiment of the invention, the synthesized composite powder contains Si particles, having a diameter of 1 to 5 μm or more, derived from the starting material.

Even if raw materials are mixed in the stoichiometric amount necessary for synthesizing layered CaSi₂ for synthesizing the CaSi_{y}-based powder, a small amount of Si particles may be contained in the resultant powder.

Whether or not coarse Si particles are contained can be determined by direct observation using SEM or TEM, or can be determined by sharpness of an X-ray diffraction peak.

While the Si particle preferably includes the Si phase only, the particle may contain inevitable impurities. However, impurities affecting properties of the Si particle are preferably small in amount.

Here, “mainly containing the Si phase” means that the Si phase is 70% or more by volume inane particle. The Si phase in one particle is preferably 80% or more by volume, and more preferably 90% or more by volume.

The content of the Si particles in the composite powder is different depending on a composition of the transition metal silicide phase, a Si/M ratio (z) of the entire composite powder, or a synthesis condition of the composite powder.

For example, when MnSiₓ-Si composite powder is synthesized at 600 to 630° C., the content of the Si particles in the composite powder is substantially uniquely determined by a composition of a Mn-silicide phase and a Si/Mn ratio (z) of the ent ire composite powder. The content of the Si particles in the composite powder typically increases with an increase in the Si/Mn ratio. This is because the MnSi_{1.73} phase is the most stable phase in the above temperature range.

At lower temperature, formation enthalpy of the MnSi phase is reversed to that of the MnSi_{1.73} phase in a particular temperature range. It is therefore considered that the amount of formation of the MnSi phase increases with decrease in temperature, and the content of the Si particles correspondingly increases.

### [1.4.2.2. Si-Nanosheet or Ca-Deficient Layered Ca-Silicide]

Here, “Si-nanosheet or Ca-deficient layered Ca-silicide” means a plate-like or nanosheet-like layered substance mainly containing the Si phase.

For example, Ca of a CaSi₂ phase is exchanged for Mn through a reaction of CaSi_{y}-based powder with Mn-chloride at 630° C., resulting in formation of a Mn-silicide phase mainly containing the MnSi_{1.73} phase and of a nanosheet-like Si phase. The nanosheet-like Si phase is conceivably caused by separation of a Si sheet layer as a component of the CaSi₂ phase during the exchange reaction. Specifically, the MnSiₓ-Si composite powder contains the nanosheet-like Si phase derived from the exchange reaction. This is the same in other transition metal elements such as Fe.

It is considered that the separated Si sheet layer is in a state where Ca is completely removed from an interlayer, or in a state where a small amount of Ca atoms remain in the interlayer. It is conceivable that when the small amount of Ca atoms remain in the interlayer, halogen atoms X are also introduced in the interlayer to maintain electric neutrality.

Specifically, “Si-nanosheet or Ca-deficient layered Ca-silicide” in the composite powder according to an embodiment of the invention means a plate-like or nanosheet-like layered substance having a composition expressed by CaᵤXᵥSi₂ (0≦u≦0.1, 0≦v≦0.2, and X denotes halogen).

The Si-nanosheet or Ca-deficient layered Ca-silicide preferably includes the Si phase only, but may contain inevitable impurities. However, impurities affecting properties of the Si-nanosheet or Ca-deficient layered Ca-silicide are preferably small in amount.

Here, “mainly containing the Si phase” means that the Si phase is 70% or more by volume in one plate-like or nanosheet-like layered substance. The Si phase in the single substance is preferably 80% or more by volume, and more preferably 90% or more by volume.

The content of the Si-nanosheet or Ca-deficient layered Ca-silicide in the composite powder varies depending on a composition of the transition metal silicide phase, the Si/M ratio (z) of the entire composite powder, or a synthesis condition of the composite powder.

Generally, the content of the Si-nanosheet or Ca-deficient layered Ca-silicide in the composite powder increases with an increase in the Si/Mn ratio or decrease in synthesis temperature.

### [1.4.3. Heterogeneous Phase]

While the transition metal silicide-Si composite powder preferably exclusively includes the transition metal silicide particles and the Si-nanosheet or Ca-deficient layered Ca-silicide, or preferably includes Si particles in addition to the above, the composite powder may contain phases (heterogeneous phases) other than those. However, a heterogeneous phase affecting properties of the composite powder is preferably small in amount.

For example, the heterogeneous phases include the following:

(1) Residue of a starting material, such as Mn-chloride and Fe chloride, and

(2) By-product of the exchange reaction, such as Mn oxide, Fe oxide, SiO₂, and Ca-chloride.

When the transition metal silicide-Si composite powder according to an embodiment of the invention is used for an anode material of a Li secondary battery, the content of the heterogeneous phases in the composite powder is preferably 1.0% or less in order to achieve high charge/discharge capacity.

Here, “content of heterogeneous phases” means a ratio of XRD maximum peak intensity of heterogeneous phases to the sum of respective XRD maximum peak intensity of the transition metal silicide phase, the Si phase, and the heterogeneous phases.

For example, “XRD maximum peak intensity of MnSi phase” means intensity of (210) plane reflection (MnSi: JCPDS card No. 00-042-1487). In addition, “XRD maximum peak intensity of MnSi_{1.73} phase” means intensity of (2, 1, 15) plane reflection (Mn₁₅Si₂₆(MnSi_{1.73}): JCPDS card No. 00-020-0724). For other known phases, XRD maximum peak intensity can be similarly known from the JCPDS card.

### [1.4.4. Charge Capacity]

When the transition metal silicide-Si composite powder according to an embodiment of the invention is used for the anode material of the Li secondary battery, charge capacity of the composite powder depends on the content of Si-phase-contained particles. Generally, the charge capacity increases with an increase in percentage of the Si-phase-contained particles in the entire composite powder. Optimization of a manufacturing condition results in transition metal silicide-Si composite powder having a charge capacity of Li ions of 500, 800, or 1000 mAh/cm³ or more at a potential window of 0.02 to 1.5 V (vs. Li) and an applied current of 100 μA.

### [2. CaSi_{y}-Based Powder for Manufacturing Transition Metal Silicide-Si Composite Powder]

The CaSi_{y}-based powder for manufacturing transition metal silicide-Si composite powder according to an embodiment of the invention (or simply called “CaSi_{y}-based powder” below) is summarized in that

a Si/Ca ratio (w) satisfies 2.0≦w≦20.0,

at least a Ca-silicide phase is contained, and

when the transition metal element (M) includes Mn only, w=2.0 is excluded.

### [2.1 Si/Ca Ratio]

The Si/Ca ratio (w) represents a molar ratio of Si to Ca in the entire CaSi_{y}-based powder.

An extremely low Si/Ca ratio results in a decrease in percentage of the Si phase in the CaSi_{y}-based powder. When such CaSi_{y}-based powder is used for a starting material to synthesize the transition metal silicide-Si composite powder, a percentage of the Si phase in the composite powder is decreased. Accordingly, the Si/Ca ratio needs to be 2.0 or more.

In contrast, an excessively high Si/Ca ratio results in a decrease in percentage of a CaSi₂ phase in the CaSi_{y}-based powder. When such CaSi_{y}-based powder is used for a starting material to synthesize the transition metal silicide-Si composite powder, a percentage of the Si phase in the composite powder is excessively increased. Accordingly, the Si/Ca ratio needs to be 20.0 or less.

### [2.2. Specific Surface Area]

The specific surface area of the CaSi_{y}-based powder for manufacturing transition metal silicide-Si composite powder according to an embodiment of the invention is not particularly limited, and may be optionally selected depending on purposes. Generally, as the specific surface area of the CaSi_{y}-based powder increases, the specific surface area of the transition metal silicide-Si composite powder synthesized using the CaSi_{y}-based powder correspondingly increases.

### [2.3. Morphology of Composite Powder]

The CaSi_{y}-based powder for manufacturing transition metal silicide-Si composite powder according to an embodiment of the invention contains at least the Ca-silicide phase. The CaSi_{y}-based powder may be a composite additionally containing the Si phase (CaSi_{y}—Si composite powder).

### [2.3.1. Ca-silicide Phase]

In an embodiment of the invention, “Ca-silicide phase” means a phase of a compound including Ca and Si (CaSi_{y}). The Ca-silicide phase specifically includes a CaSi₂ phase and a CaSi phase.

As described later, since the CaSi_{y}-based powder according to the embodiment of the invention is synthesized under a condition that Si is contained in the amount equal to or higher than the stoichiometric amount necessary for forming CaSi₂, the Ca-silicide phase typically includes the CaSi₂ phase. However, the CaSi_{y}-based powder contains another Ca-silicide phase such as CaSi phase in some cases depending on a manufacturing condition. In the embodiment of the invention, the CaSi_{y}-based powder may contain Ca-silicide other than the CaSi₂ phase.

Among them, the CaSi₂ phase has a layered structure where Ca is intercalated between layers of graphite-like Si sheets. While the CaSi₂ phase is in a molar ratio of Ca/Si=1/2 in an equilibrium state, Si deficiency is likely to occur in a non-equilibrium state. If Si deficiency becomes extremely large, however, the layered structure is estimated to be hardly maintained.

The CaSi_{y}-based powder for manufacturing transition metal silicide-Si composite powder according to the embodiment of the invention may contain one of the various CaSi₂ phases different in composition (amount of Si deficiency), or may contain two or more of the phases.

### [2.3.2. Si Phase]

When the CaSi_{y}-based powder according to the embodiment of the invention is synthesized under a condition of excess Si, the CaSi_{y}-based powder contains an excess Si phase. When the CaSi_{y}-based powder is synthesized using a method described later, the excess Si phase is typically lamellarly dispersed in the Ca-silicide phase.

Even if a Ca source and a Si source are mixed in the stoichiometric amount necessary for synthesizing the layered CaSi₂, a small amount of Si phase may be contained in the synthesized powder. It is considered that this is because Si deficiency partially occurs in the layered CaSi₂, or a small amount of CaSi phase coexists.

The content of the Si phase in the CaSi_{y}-based powder is substantially uniquely determined by a composition of the Ca-silicide phase and a Si/Ca ratio of the entire composite powder. Generally, the content of the Si phase in the CaSi_{y}-based powder increases with an increase in the Si/Ca ratio.

### [2.3.3. Heterogeneous Phase]

While the CaSi_{y}-based powder preferably includes the Ca-silicide phase only or preferably includes the Si phase in addition to this, the powder may contain phases (heterogeneous phases) other than the above. However, a heterogeneous phase affecting properties of the CaSi_{y}-based powder is preferably small in amount.

For example, the heterogeneous phases include the following:

(1) Residue of a starting material, and

(2) By-product of the exchange reaction such as SiO₂.

When the CaSi_{y}-based powder according to the embodiment of the invention is used to synthesize the transition metal silicide-Si composite powder, the content of the heterogeneous phases in the CaSi_{y}-based powder is preferably 1.0% or less in order to obtain transition metal silicide-Si composite powder having high charge/discharge capacity.

Here, “content of heterogeneous phases” means a ratio of XRD maximum peak intensity of heterogeneous phases to the sum of respective XRD maximum peak intensity of the Ca-silicide phase, the Si phase, and the heterogeneous phases.

For example, “XRD maximum peak intensity of CaSi phase” means intensity of (111) plane reflection (CaSi: JCPDS card No. 00-026-0324). In addition, “XRD maximum peak intensity of CaSi₂ phase” means intensity of a relatively high XRD peak between (0, 0, 12) plane reflection and (107) plane reflection (CaSi₂: JCPDS card No. 00-001-1276). XRD maximum peak intensity may be similarly known from the JCPDS card for each of other known phases.

### [3. Method of Manufacturing CaSi_{y}-Based Powder for Manufacturing Transition Metal Silicide-Si Composite Powder]

A method of manufacturing the CaSi_{y}-based powder for manufacturing transition metal silicide-Si composite powder according to an embodiment of the invention includes a melting step and a solidification step.

### [3.1. Melting Step]

In the melting step, a Ca source is mixed with a Si source into a Si/Ca ratio (molar ratio) (w) of 2.0≦w≦20.0, and the mixed sources are melted.

Pure Ca or CaSi can be used for the Ca source. Similarly, pure Si or CaSi can be used for the Si source.

The Ca source and the Si source are mixed in such a manner that the Si/Ca ratio (molar ratio) is within the above range. Generally, an increase in Si/Ca ratio results in an increase in Si phase in composite powder. A preferable range of Si/Ca ratio (w) is described as before, and description thereof is omitted.

The melting method is not particularly limited, and various melting methods such as an arc melting method, can be used. Melting of raw materials is preferably performed at an inert-gas atmosphere to prevent the raw materials from being oxidized.

Any melting condition may be used as long as uniform molten material is obtained under the condition.

### [3.2. Solidification Step]

In the solidification step, the molten material obtained in the melting step is solidified to obtain the CaSi_{y}-based powder for manufacturing transition metal silicide-Si composite powder according to the embodiment of the invention. A molten material composition and/or a solidification condition are optimized in solidification of the molten material, resulting in a solidified body containing a predetermined amount of Ca-silicide phase and a predetermined amount of Si phase. The solidified body is directly used for the CaSi_{y}-based powder for manufacturing transition metal silicide-Si composite powder, or milled before use as necessary.

Solidification may be performed by slowly or rapidly cooling the molten material. In particular, when the molten material is rapidly solidified, the Ca-silicide phase and the Si phase are easily refined.

A rapid solidification method specifically includes the following:

(1) A method where raw material is melted in a nozzle and such molten material is sprayed or dropped on a rotating cupper roll as cooling medium (cupper roll method), and

(2) A method where raw material is melted in a nozzle and such molten material is sprayed or dropped from a nozzle hole, and a jet fluid is blown to a flow of the molten material from the surrounding to solidify droplets of the molten material while falling (atomization method).

When the atomization method is used as the rapid solidification method, inert gas, for example, Ar, is preferably used for the jet fluid to prevent oxidation of the molten material.

### [4. Method of Manufacturing Transition Metal Silicide-Si Composite Powder]

A method of manufacturing the transition metal silicide-Si composite powder according to an embodiment of the invention includes a mixing step, a reaction step, and a washing step. The method according to the embodiment of the invention may additionally include a magnetic separation step.

### [4.1. Mixing Step]

In the mixing step, the CaSi_{y}-based powder for manufacturing transition metal silicide-Si composite powder according to the embodiment of the invention is mixed with halide of a transition metal element (M).

In the mixing step, the CaSi_{y}-based powder is preferably mixed with the halide of the transition metal element (M) such that a M/Ca ratio (molar ratio) (α) satisfies α≧1.

For example, when halide of the transition metal (M) is MnCl₂, a reaction of CaSi₂ with MnCl₂ in the CaSi_{y}-based powder can be ideally expressed as the following formula (1):

CaSi₂+αMnCl₂→MnSiₓ+(2−x)Si+(α−1)MnCl₂+CaCl₂ (1)

When the reaction proceeds according to the formula (1), in the case that a (Mn/Ca ratio) is 1, MnCl₂ is ideally entirely consumed for a reaction with CaSi₂. When a exceeds 1, unreacted MnCl₂ remains. However, since both the unreacted MnCl₂ and CaCl₂ as a by-product are soluble in a solvent (for example, ethanol), the MnCl₂ and CaCl₂ are relatively easily removed from a reaction product. Thus, a is preferably 1 or more.

Addition of a larger amount of MnCl₂ than necessary not only has no practical benefit, but also causes an increase in man-hour for removing the unreacted MnCl₂. Thus, a is preferably 5 or less. More preferably, α is 4 or less and still more preferably 3 or less.

When α is less than 1, CaSi₂ remains in synthesized powder. While the CaSi₂ is hardly removed in the washing step described later, the CaSi₂ may be practically harmless depending on a use. In such a case, α may be less than 1.

### [4.2. Reaction Step]

In the reaction step, the mixture obtained in the mixing step is heated and cooled.

Any heating temperature may be used, as long as the halide of the transition metal element (M) efficiently reacts with the CaSiy-based powder at the temperature.

Generally, when heating temperature is extremely low, a reaction is hardly finished within a practical time. The heating temperature is therefore preferably equal to or higher than 30% of the melting point (Tₘ) of the halide of the transition metal element (M). More preferably, the heating temperature is equal to or higher than 35%, 40%, or 50% of Tₘ.

When the heating temperature is extremely high, melting of a raw material occurs, resulting in formation of coarse powder, or a percentage of the Si-phase-contained particles is decreased. The heating temperature is therefore preferably equal to or lower than 98% of the melting point (Tₘ) of the halide of the transition metal element (M). More preferably, the heating temperature is equal to or lower than 95%, 90%, 85%, 80%, 75%, or 70% of Tₘ.

When the composite powder according to the embodiment of the invention is used as an anode material of a Li secondary battery, the heating temperature is preferably set to a temperature allowing a material to have a charge capacity of Li ions of 500 mAh/cm³ or more at a potential window of 0.02 to 1.5 V and an applied current of 100 μA.

Optimum heating temperature is different depending on a kind of the transition metal element (M). While the optimum heating temperature may be experimentally obtained, the temperature may be thermodynamically predicted in consideration of formation enthalpy.

For example, when MnSiₓ-Si composite powder is synthesized, the heating temperature is preferably 400 to 630° C. More preferably, the heating temperature is 500 to 630° C.

For example, when FeSiₓ-Si composite powder is synthesized, the heating temperature is preferably 300 to 500° C. More preferably, the heating temperature is 350 to 450° C.

When a raw material contains two or more transition metal elements (M), the heating temperature only needs to meet the above condition for at least one halide of transition metal element (M).

Heating time is optimally selected depending on the heating temperature. The heating time is typically 1 to 50 hours depending on the heating temperature.

Heating is preferably performed in an inert atmosphere to prevent oxidation of the raw materials.

When the reaction is finished, a reaction product is cooled. Cooling may be performed rapidly or slowly.

### [4.3. Washing Step]

In the washing step, the reaction product obtained in the reaction step is washed by one or more solvents that may dissolve the halide of the transition metal element (M) and/or Ca-halide so that unreacted halide of the transition metal element (M) and the Ca-halide are removed.

Washing is performed to remove the unreacted halide (for example, MnCl₂) of the transition metal element (M) and the Ca-halide (for example, CaCl₂) as the by-product. The solvent used for the washing may dissolve one of the halide of the transition metal element (M) and the Ca-halide, or may dissolve the two.

In the case of using the solvent that may dissolve one of the halide of the transition metal element (M) and the Ca-halide, washing needs to be performed in two stages, or a mixed solvent needs to be used. In the case of using the solvent that may dissolve the two, washing can be performed in one stage using a single solvent. When the reaction is performed under a condition of no residual, unreacted halide of the transition metal element (M), the washing can be performed in one stage using a solvent that may dissolve at least the Ca-halide.

For example, when the halide of the transition metal element (M) is MnCl₂ and the Ca-halide is CaCl₂, solvents that may dissolve the two include, for example, ethanol and water.

One of the solvents may be singly used, or two or more of the solvents may be mixedly used.

After the washing, solid contents are separated, resulting in the transition metal silicide-Si composite powder according to the embodiment of the invention. The obtained transition metal silicide-Si composite powder may be directly used for various applications, or may be milled before use as necessary. Alternatively, the washed powder may be provided for the magnetic separation step described below.

### [4.4. Magnetic Separation Step]

In the magnetic separation step, the washed composite powder is re-dispersed in a solvent, and magnetic powder is separated from such a powder-dispersed liquid.

Some transition metal silicide exhibits magnetism (for example, Fe₃Si). The transition metal silicide functions as an electron conductor, and is typically low in charge capacity of Li ions. When the composite powder contains an excess amount of transition metal silicide, high charge capacity of Li ions is hardly achieved.

When the transition metal silicide in the synthesized composite powder contains a magnetic material, magnetic separation of the composite powder is performed, making it possible to control a percentage of the transition metal silicide particles in the composite powder. This makes it possible to increase a percentage of the Si-phase-contained particles in the powder after separation, leading to increase in charge capacity.

While the solvent for the magnetic separation is not particularly limited, a solvent that may disperse the composite powder is used.

The magnetic separation is performed through applying a magnetic field to the powder-dispersed liquid. A method of applying the magnetic field includes, for example, dipping of a magnet in the powder-dispersed liquid.

[5. Effects of Transition Metal Silicide-Si Composite Powder and Method of Manufacturing the Composite Powder, and Effects of CaSi_{y}-Based Powder for Manufacturing Transition Metal Silicide-Si Composite Powder and Method of Manufacturing the CaSi_{y}-Based Powder]

In synthesizing CaSi_{y} from the Ca source and the Si source, the Si source is added in the amount equal to or higher than the stoichiometric amount necessary for forming the layered CaSi₂, resulting in CaSi_{y}-based powder containing the Ca-silicide phase, or in CaSi_{y}-based powder including a composite of the Ca-silicide phase and the Si phase.

Next, the CaSi_{y}-based powder and halide of the transition metal element (M) (for example, Mn-chloride) are mixed in a predetermined ratio and heated at a predetermined temperature, resulting in a reaction product containing transition metal silicide particles, Si-nanosheet or Ca-deficient layered Ca-silicide, and Ca-halide. When an excess amount of halide of the transition metal element (M) is mixed, the reaction product further contains unreacted halide of transition metal element (M).

Since both the Ca-halide and the halide of the transition metal element (M) are soluble in a solvent (for example, ethanol), the reaction product is washed by an appropriate solvent, resulting in the transition metal silicide-Si composite powder.

For example, MnSiₓ-Si composite powder can also be manufactured by melting and casting Mn—Si molten metal containing excess Si. However, such a melting/casting method results in only coarse particles. In another method, an ingot is mechanically milled by a ball mill or the like. However, the method makes the milled particles amorphous, and hardly generates particles having high crystallinity. Furthermore, impurities are inevitably mixed in from balls or a container.

Nanocomposite powder, including Mn-silicide particles having high crystallinity, Si particles, and Si-nanosheet or Ca-deficient layered Ca-silicide, is obtained through a reaction of CaSi_{y}-based powder (w>2) with Mn-chloride in a manner that Ca of the Ca-silicide phase is exchanged for Mn of the Mn-chloride.

The obtained MnSiₓ-Si composite powder contains fine Mn-silicide particles formed through a reaction of the CaSi₂ phase with the Mn-chloride, and contains the Si-nanosheet or Ca-deficient layered Ca-silicide, leading to large specific surface area. Moreover, the composite powder is not necessary to be milled for refining particles, leading to low impurity amount.

Furthermore, the MnSiₓ-Si composite powder includes the Mn-silicide particles (conductive material) having high crystallinity, the Si particles (insertion/extraction body of Li ions) derived from the raw material, and the Si-nanosheet or Ca-deficient layered Ca-silicide (insertion/extraction body of Li ions), which are compounded with one another in nanometer level, and therefore the composite powder exhibits high charge/discharge capacity when used for an anode material of a Li secondary battery. Furthermore, such a compounded structure relaxes change in volume of Si induced by insertion/extraction of Li ions, leading to high durability.

In the case of a transition metal element (M) other than Mn, silicide can be theoretically synthesized from halide of the transition metal element (M) in the same way as above. In addition, reaction of the halide of the transition metal element (M) with CaSi_{y}-based powder results in nanocomposite powder including at least transition metal silicide particles having high crystallinity and Si-nanosheet or Ca-deficient layered Ca-silicide.

For example, when the halide of the transition metal element (M) is FeCl₂, Ca of CaSi₂ as a raw material serves as a reducing agent in a reaction of CaSi₂ with FeCl₂. Formally, it is considered that the reaction proceeds while Ca of CaSi₂ is substituted for Fe of FeCl₂. Here, separation occurs in the layered structure of CaSi₂, so that the Si-nanosheet or Ca-deficient layered Ca-silicide is formed, and concurrently CaCl₂ is formed through a reaction of Ca with chlorine. Moreover, Fe-silicide is estimated to be formed through a reaction of residual Fe with part of the Si-nanosheet or Ca-deficient layered Ca-silicide.

When a Ca-haloid salt (CaCl₂) formed through the reaction is stable compared with a source salt (transition metal haloid salt such as FeCl₂), the above reaction proceeds. Stability of a salt is determined by ionization tendency of metal elements, and the reaction is expected to proceed for all transition metal haloid salts.

A formation phase of silicide is determined thermodynamically and kinetically as follows. For example, Fe-silicide includes a plurality of phases such as FeSi, Fe₃Si, and FeSi₂. A particular phase to be formed is determined by formation enthalpy of the respective phases. When reaction time is sufficiently long, a relatively stable phase at a synthesis temperature is formed. When reaction time is insufficient, or when the phases have similar formation enthalpy, a plurality of phases are likely to coexist.

As for the plate-like or sheet-like Si-nanosheet or Ca-deficient layered Ca-silicide contained in the powder, Ca escapes from the layered CaSi₂ as a raw material, and the Si sheet layer is thus separated, so that the Si-nanosheet is formed. It is therefore considered that formation of the Si-nanosheet hardly depends on kinds of transition metal silicide formed concurrently.

A content ratio of the transition metal silicide to the Si-nanosheet or Ca-deficient layered CaSi₂ is determined by formation conditions. Generally, it is estimated that a percentage of the transition metal silicide increases with an increase in reaction temperature or in reaction time. As for a ratio of the Ca-deficient layered CaSi₂ to the Si-nanosheet from which Ca completely escapes, it is also estimated that the amount of the Si-nanosheet increases with an increase in reaction temperature or in reaction time.

### EXAMPLES

### Examples 1 and 2 and Comparative Example 1

### [1. Sample Preparation]

### [1.1. Synthesis of CaSi₂-Si Composite Powder]

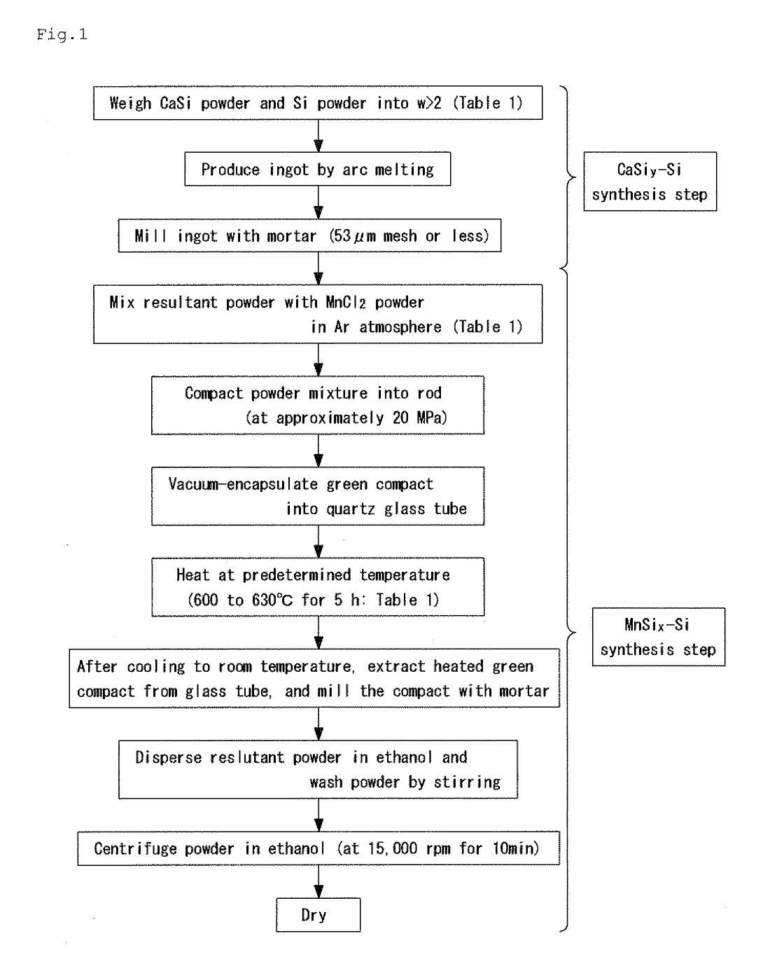

An upper side of FIG. 1 shows a synthesis procedure of CaSi₂-Si composite powder. First, a predetermined amount of CaSi powder and of Si powder were weighed and mixed. The raw materials were melted and solidified by an arc melting method, so that an ingot (Arc-ingot material) was produced. The ingot was milled with a mortar (53 μm mesh or less), so that CaSi₂-Si composite powder was obtained. A Si/Ca ratio (w: ICP analysis value) was approximately equal to that of the nominal composition, 2.11 (Example 1) or 2.20 (Example 2).

For comparison, CaSi_{y} powder was synthesized in the same way as the Examples 1 and 2 except that raw materials were mixed such that the Si/Ca ratio (w) was 1.97 in ICP analysis value (Comparative example 1)

### [1.2. Synthesis of MnSiₓ-Si Composite Powder]

A lower side of FIG. 1 shows a synthesis procedure of MnSiₓ-Si composite powder. First, the milled CaSi_{y}—Si composite powder was mixed with MnCl₂ powder in Ar atmosphere. A Mn/Ca ratio (α) was 2. A resultant powder mixture was compacted into a rod (at approximately 20 MPa), and a resultant green compact was vacuum-encapsulated into a quartz glass tube. The quartz glass tube was heated at a predetermined temperature (600 to 630° C. for 5 h).

The quartz glass tube was cooled to room temperature, and then the heated green compact was extracted from the glass tube, and milled with a mortar. Resultant powder was dispersed in ethanol, and stirred to be washed. After washing, the powder in the ethanol was centrifuged (at 15,000 rpm for 10 min.). Then, a solid content was dried, so that MnSiₓ-Si composite powder was obtained (Examples 1 and 2).

MnSiₓ-Si composite powder was synthesized in the same way as the Examples 1 and 2 except that the CaSi_{y} powder obtained in the Comparative example 1 was used as a starting material.

Table 1 shows a synthesis condition of each powder.

TABLE 1

| | w | α | Temperature(° C.) |
|---|---|---|---|
| Comparative example 1 | 1.97 | 2.0 | 600 |
| Example 1 | 2.11 | 2.0 | 630 |
| Example 2 | 2.20 | 2.0 | 630 |

* w = Si/Ca, CaSi_{y}—Si + αMnCl₂ → heating

### [2. Test Method]

[2.1. Powder Composition]

A composition of synthesized powder was measured using ICP.

### [2.2. Density]

Density of the synthesized powder was measured using a pycnometer.

### [2.3. Specific Surface Area]

Specific surface area of the synthesized powder was calculated by a BET method using a nitrogen adsorption isotherm.

### [2.4. X-ray Diffraction]

X-ray Diffraction of the synthesized powder was performed to identify a formed phase.

### [2.5. SEM and TEM]

The synthesized powder was observed with SEM and TEM. A TEM observation sample was prepared by dispersing a powder sample in ethanol and dropping the powder-dispersed liquid onto a TEM grid.

### [2.6. Charge/Discharge Characteristic]

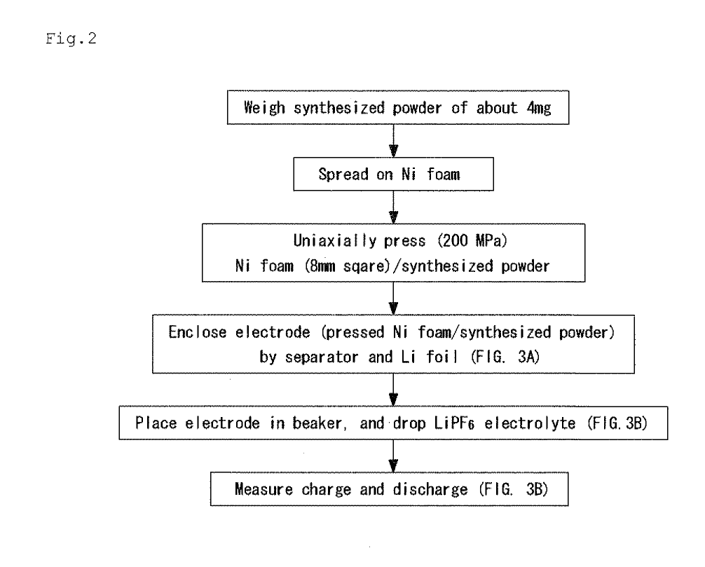

Evaluation electrodes were prepared and a charge/discharge characteristic of each electrode was evaluated according to a procedure shown in FIG. 2.

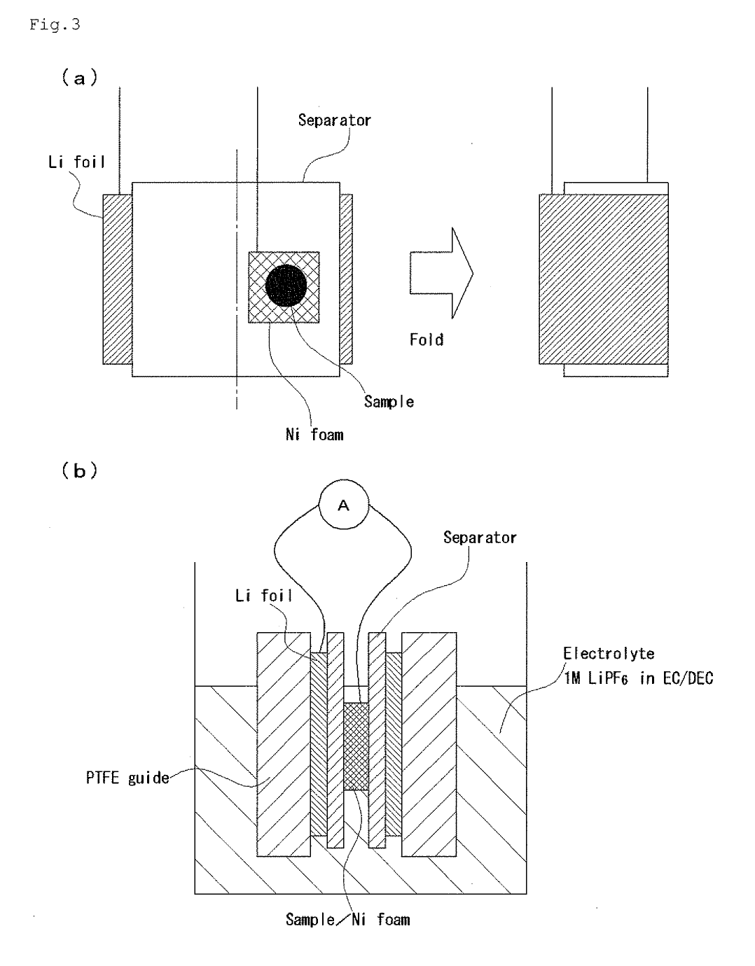

First, the synthesized powder of about 4 mg was weighed, and spread on a Ni foam of 8 mm square. The synthesized powder-on-Ni foam was subjected to uniaxial press (at 200 MPa). As shown in FIG. 3A, the synthesized powder-on-Ni foam connected with a lead wire was enclosed by a separator, and still further externally enclosed by a Li foil connected with a lead wire, so that the evaluation electrode was formed.

Next, as shown in FIG. 3B, both sides of the evaluation electrode were held by polytetrafluoroethylene (PTFE) guides, and the electrode with the guides was placed in a beaker. An electrolyte (solvent: ethylene carbonate (EC)/diethylene carbonate (DEC); EC/DEC=3/7 (volume ratio)) containing 1M LiPF₆ was dropped into the beaker, and charge/discharge capacity of the electrode was measured at a constant current (10 or 20 μA).

The capacity was evaluated assuming that a change process of an electric potential from 1.5 V to 0.02 V was one cycle of charge and discharge. An electric potential of the sample changes with intercalation and deintercalation of Li. A deintercalation process of Li from the sample was assumed as a charge process. Table 2 shows a measurement condition of charge/discharge capacity.

TABLE 2

| | Sample[mg] | Current value[μA] |
|---|---|---|
| Comparative example 1 | 4.4 | 10 |
| Example 1 | 3.9 | 10 |
| Example 2 | 4.1 | 20 |

Voltage: 0.02~1.5 V

### [3. Results]

### [3.1. Powder Composition]

Respective compositions of the CaSi_{y}—Si composite powder and the MnSiₓ-Si composite powder synthesized in the Examples 1 and 2 and respective compositions of the CaSi_{y}—Si composite powder and the MnSiₓ-Si composite powder synthesized in the Comparative example 1 were approximately equal to respective nominal compositions.

### [3.2. Density and Specific Surface Area]

Table 3 shows density and specific surface area of the MnSiₓ-Si composite powder synthesized in each of the Examples 1 and 2 and the Comparative example 1. Table 3 additionally shows z (Si/Mn ratio) in ICP analysis value.

Table 3 reveals the following:

(1) Density decreases with increase in Si/Mn ratio (z). This is conceivably because a percentage of the Si phase increases with an increase in z,

(2) Specific surface area of the powder is different depending on the Si/Mn ratio (z). This is conceivably because a ratio between Mn-silicide particles, Si particles, and Si-nanosheet changes depending on z.

TABLE 3

| | | Density | Specific surface area |
|---|---|---|---|
| | z* | [g/cm³] | [m²/g] |
| Comparative Example 1 | 1.98 | 4.48 | 10.91 |
| Example 1 | 2.05 | 3.97 | 3.31 |
| Example 2 | 2.19 | 3.95 | 5.46 |

*z = Si/Mn

### [3.3. X-Ray Diffraction]

[3.3.1. CaSi_{y}—Si Composite Powder]

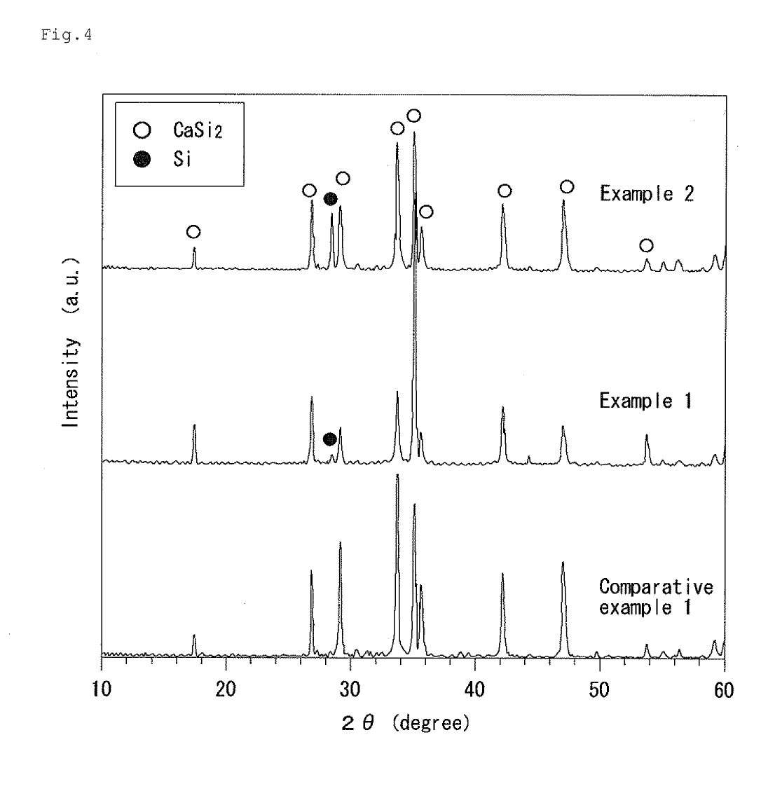

FIG. 4 shows respective X-Ray diffraction patterns of the CaSi_{y}—Si composite powder synthesized in the Examples 1 and 2 and of the CaSi_{y} powder synthesized in the Comparative example 1.

The powder synthesized in the Comparative example 1 was identified to have a single phase of CaSi₂. The powder obtained in each of the Examples 1 and 2 was identified as a composite including a CaSi₂ phase and a Si phase. FIG. 4 reveals that a Si peak becomes higher with increase in Si/Ca ratio (w).

### [3.3.2. MnSiₓ-Si Composite Powder]

FIG. 5 shows respective X-Ray diffraction patterns of the MnSiₓ-Si composite powder obtained in the Examples 1, 2 and the Comparative example 1.

The powder obtained through a reaction with Mn-chloride in each of the Examples 1, 2 and the Comparative example 1 was identified as a composite including a MnSi₁₇₃ phase and a Si phase. While a Si peak of the Comparative example 1 is low in FIG. 5, it was confirmed from TEM observation that the Si-nanosheet was contained in the powder in each of the Examples 1, 2 and the Comparative example 1. FIG. 5 reveals that a Si peak becomes higher with increase in Si/Mn ratio (z).

### [3.4. SEM Observation and TEM Observation]

[3.4.1. CaSi_{y}—Si Composite Powder]

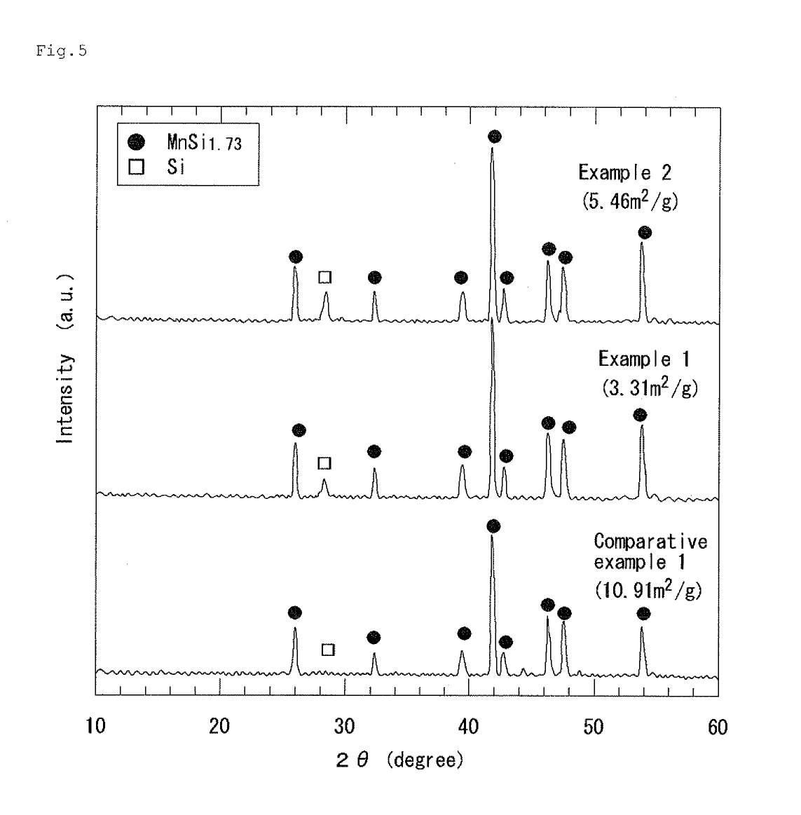

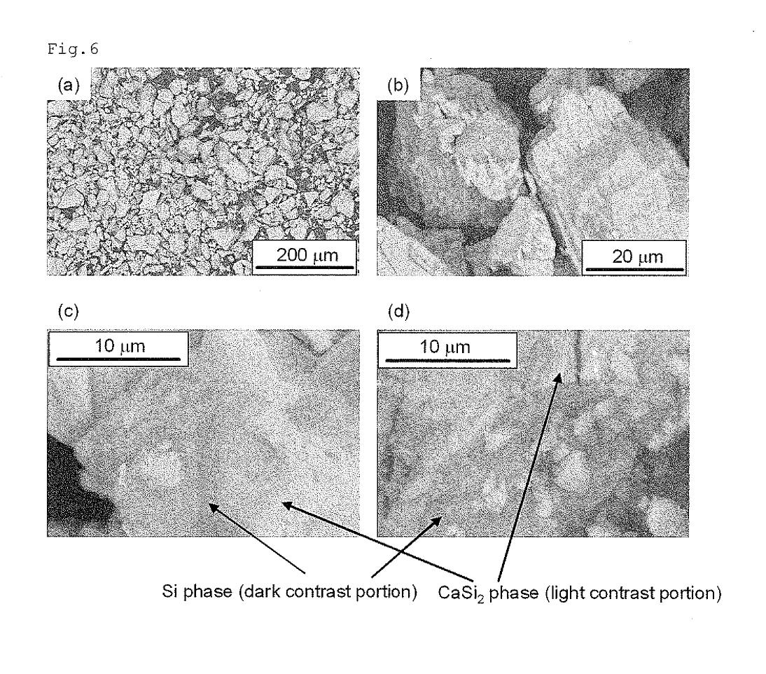

FIGS. 6A to 6D show SEM images of the CaSi_{y}—Si composite powder obtained in the Example 2. FIG. 6A shows a low-magnification SEM image, FIG. 6B shows a middle-magnification SEM image, and FIGS. 6C and 6D show high-magnification SEM images (two visual fields).

Particle diameter of the CaSi_{y}—Si composite powder obtained in the Example 2 was several to several dozen micrometers. In addition, the CaSi₂ phase and the Si phase were mixedly found in one particle. The Si phase is estimated to be lamellarly dispersed in the CaSi₂ phase.

Although not shown, observation results of the CaSi_{y}—Si composite powder of the Example 1 were the same as those of the Example 2.

### [3.4.2. MnSiₓ-Si Composite Powder]

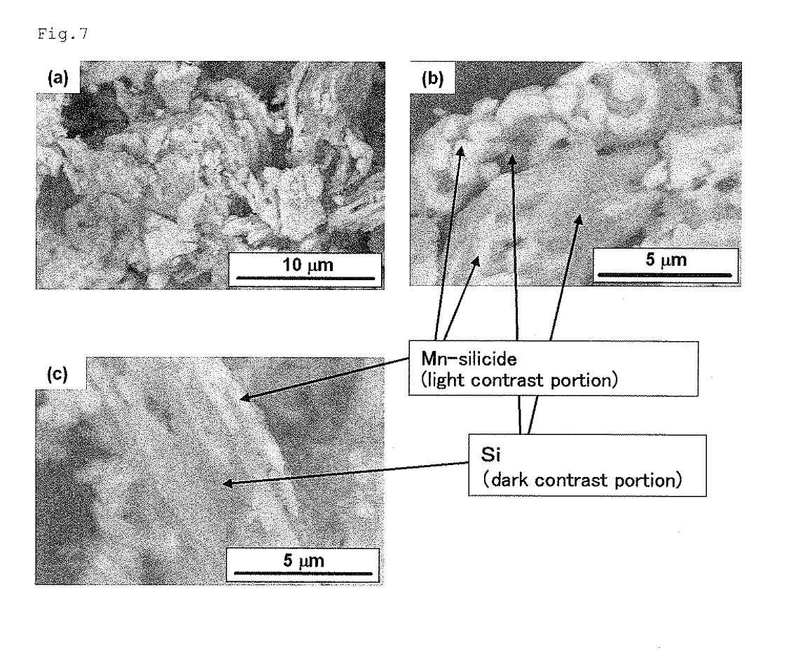

FIGS. 7A to 7C show SEM images of the MnSiₓ-Si composite powder obtained in the Example 2. FIG. 7A shows a low-magnification SEM image, and FIGS. 7B and 7c show high-magnification SEM images (two visual fields).

The MnSiₓ-Si composite powder obtained in the Example 2 includes Mn-silicide having a particle diameter of several dozen to several hundred nanometers and Si. In the SEM images of FIGS. 7A to 7C, white contrast portions represent Mn-silicide, and gray contrast portions represent Si. The Si particles have a diameter of approximately one to several micrometers, where Mn-silicide particles adhere to respective surfaces of the Si particles.

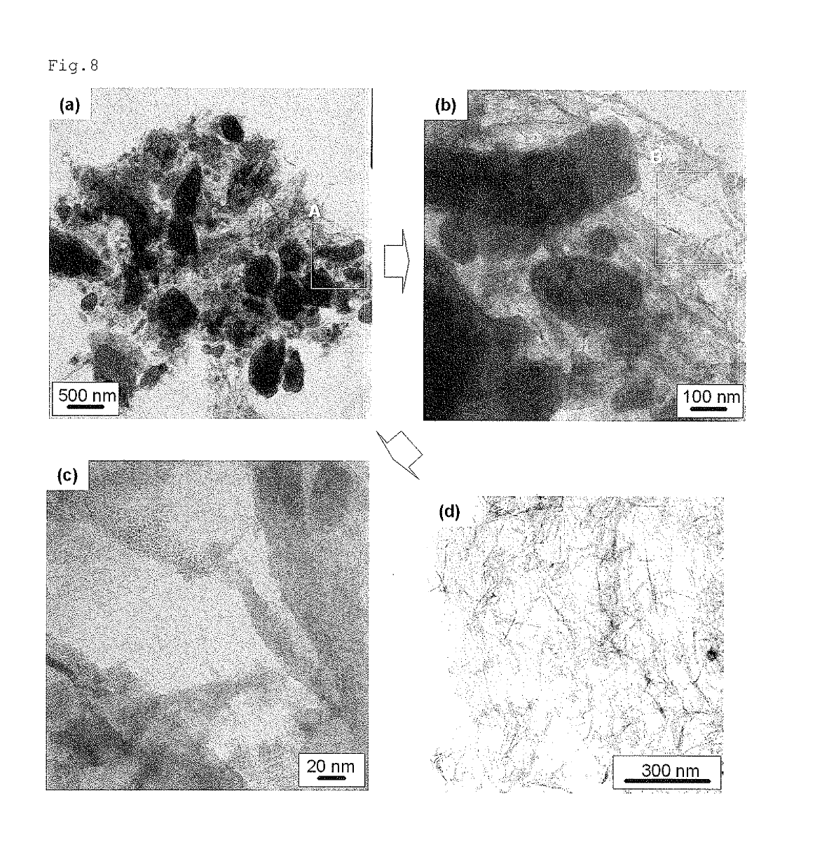

FIGS. 8A to 8D show TEM images of the MnSiₓ-Si composite powder obtained in the Example 2. FIG. 8A shows a low-magnification TEM image, FIG. 8B shows a middle-magnification TEM image showing enlargement of a portion A of FIG. 8A, and FIG. 8C shows a high-magnification TEM image showing enlargement of a portion B of FIG. 8B. FIG. 8D shows a low-magnification TEM image of a portion different from that in FIGS. 8A to 8C.

The TEM images of FIGS. 8A to 8D identifiably showed a state where Mn-silicide (each black contrast portion) and Si (each unclear contrast portion around the black contrast portion, estimated as nanosheet-like Si) mixedly existed. The Si was estimated to have a thickness of approximately monoatomic layer and a diameter of approximately 1 μm.

FIG. 8C conceivably shows a contrast produced by a portion of a single Si-nanosheet (having a thickness of approximately monoatomic layer) and a portion including several sheets of Si-nanosheet overlapping with one another. A streaky black contrast in FIG. 8D is conceivably produced by turning and bending of a Si sheet, and diameter of the Si sheet is estimated to be approximately 1 μm from length of the black contrast.

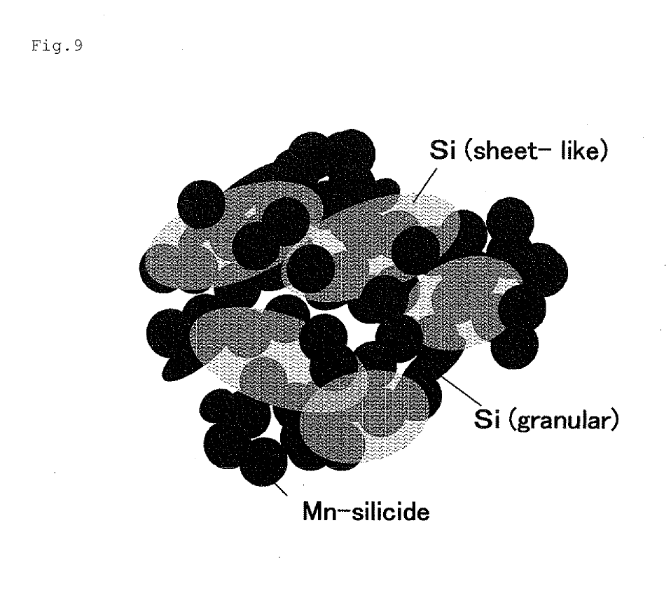

CaSi₂ in the raw material is a layered compound including Si sheet layers and Ca layers being alternately laminated. The Si-nanosheet in the TEM images is estimated to be caused by separation of the Si sheet layer of CaSi₂. FIG. 9 shows a schematic diagram of composite powder estimated from the SEM and TEM images. As shown in FIG. 9, the powder obtained in the Example 2 is considered to include Mn-silicide particles, Si-nanosheet, and Si particles compounded with one another in nano level.

### [3.4. Charge/Discharge Characteristic]

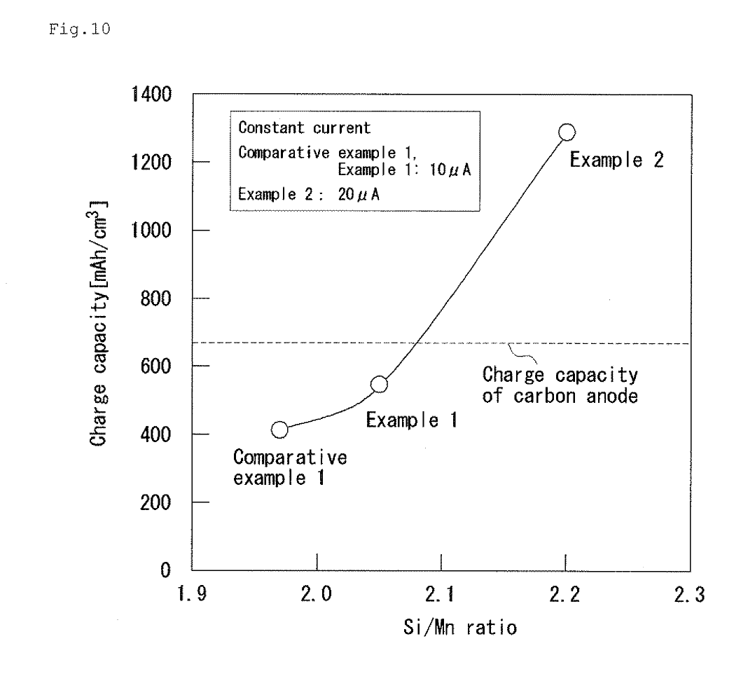

FIG. 10 shows a relationship between a Si/Mn ratio and charge capacity of the MnSiₓ-Si composite powder. FIG. 10 additionally shows charge capacity of artificial graphite MCF (a material equivalent to a carbon anode used for current Li secondary batteries). The carbon anode is formed by attaching a sheet of the artificial graphite mixed with polytetrafluoroethylene (5 wt %) to a Ni mesh.

FIG. 10 reveals that the MnSiₓ-Si composite powder obtained in the Example 1 or 2 exhibits charge capacity equal to or higher than the carbon anode.

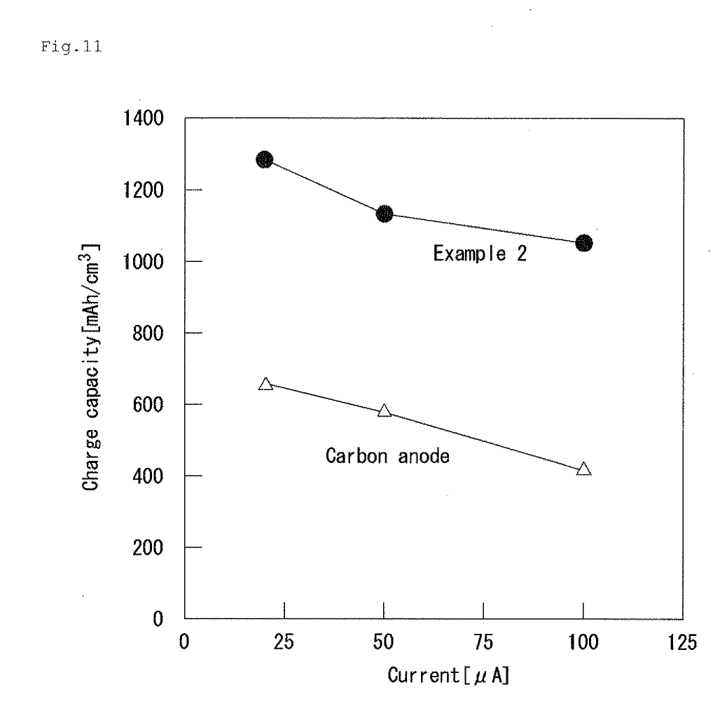

FIG. 11 shows a relationship between an applied current value and charge capacity (delithiation amount) of the MnSiₓ-Si composite powder obtained in the Example 2. FIG. 11 additionally shows a result of the carbon anode.

As shown in FIG. 11, the composite powder obtained in the Example 2 maintains high charge capacity even if the applied current value is increased (which corresponds to an increase in charge/discharge rate).

This is conceivably because Mn-silicide, which is considered to be mainly responsible for electronic conduction, and Si, which is considered to be mainly responsible for a reaction with Li, are mixed in nano level as shown in FIG. 9, and therefore both a diffusion path of Li and a conduction path of electrons are appropriately formed.

### Examples 11 to 13 and Comparative Example 11

### [1. Sample Preparation]

### [1.1. Synthesis of CaSi_{y}—Si Composite Powder (CaSi_{2.05} Powder)]

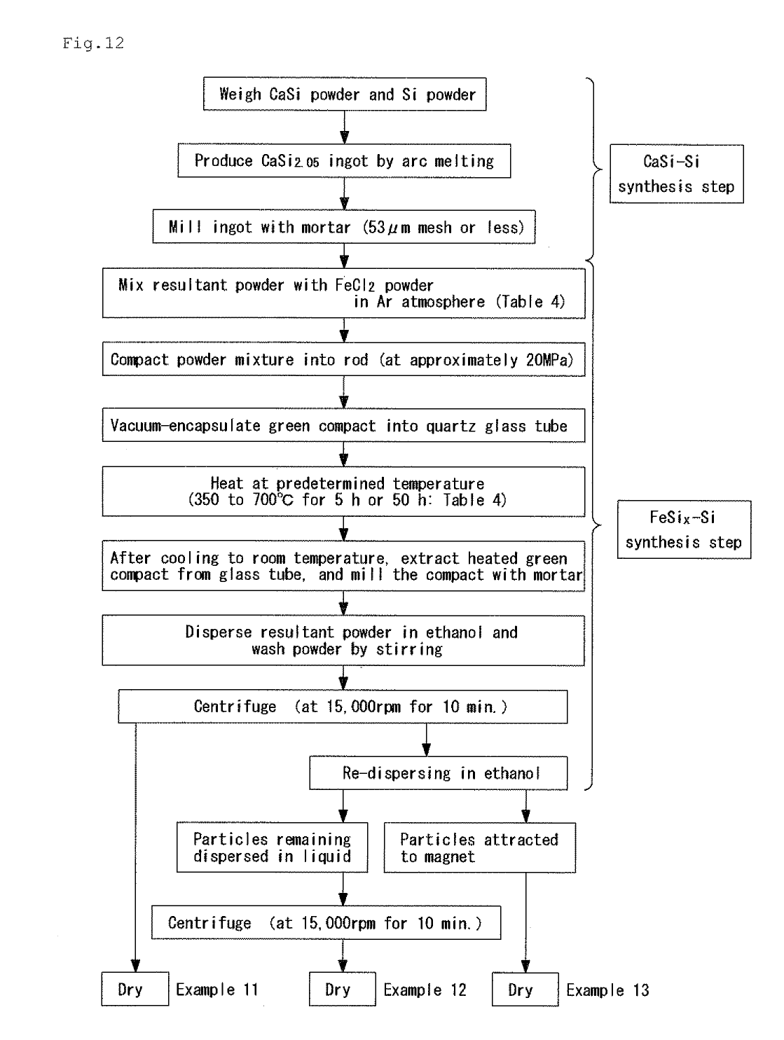

An upper side of FIG. 12 shows a synthesis procedure of CaSi_{y}—Si composite powder. First, a predetermined amount of CaSi powder and of Si powder were weighed and mixed. The raw materials were melted and solidified by an arc melting method, so that an ingot (Arc-ingot material) was produced. The ingot was milled with a mortar (53 μm mesh or less), so that CaSi_{y}—Si composite powder was obtained. A Si/Ca ratio (w: ICP analysis value) was approximately equal to that of the nominal composition, 2.05.

### [1.2 Synthesis of FeSiₓ-Si Composite Powder]

A lower side of FIG. 12 shows a synthesis procedure of FeSiₓ-Si composite powder. First, the milled CaSi_{y}—Si composite powder was mixed with FeCi₂ powder in Ar atmosphere. A Fe/Ca ratio (α) was 2. A resultant powder mixture was compacted into a rod (at approximately 20 MPa), and a resultant green compact was vacuum-encapsulated into a quartz glass tube. The quartz glass tube was heated at a predetermined temperature for a predetermined time. A heating condition was as follows: at 400° C. for 5 hours (Example 11) or at 350° C. for 5 hours (Examples 12 and 13).

The quartz glass tube was cooled to room temperature, and then a heated green compact was extracted from the tube, and milled with a mortar. Resultant powder was dispersed in ethanol, and stirred to be washed. After washing, the powder in the ethanol was centrifuged (at 15,000 rpm for 10 min.). Then, solid contents were dried, so that powder was obtained (Example 11).

The powder subjected to the heat treatment of 350° C. for 5 hours was re-dispersed in ethanol after having been centrifuged. A magnet was dipped in the powder-dispersed liquid so that part of the powder was attracted by the magnet. Particles remaining dispersed in the liquid were centrifuged (at 15,000 rpm for 10 min.). Then, a solid content was dried to obtain powder (Example 12). The particles attracted to the magnet were directly dried to obtain powder (Example 13).

Table 4 shows a synthesis condition of each powder.

TABLE 4

| | α | Temperature(° C.) | Time(h) |
|---|---|---|---|
| Example 11 | 2.0 | 400 | 5 |
| Example 12 | 2.0 | 350 | 5 |
| Example 13 | 2.0 | 350 | 5 |

* CaSi_{2.05} + αFeCl₂ → heating
Synthesis procedure is as shown in FIG. 12.
Note:
Melting point of FeCl₂ is 670° C.

### [2. Test Method]

### [2.1. Powder Composition, Density, Specific Surface Area, X-ray Diffraction, SEM and TEM]

For the powder, measurement of a composition, density, and specific surface area, X-ray diffraction, and observation using SEM and TEM were performed according to the same procedures as in the Example 1.

### [2.2. Charge/Discharge Characteristic]

Evaluation electrodes were prepared and a charge/discharge characteristic of each electrode was evaluated according to the same procedure as in the Example 1 except that a current value was 100 μA.

Table 5 shows a measurement condition of charge/discharge capacity. The Comparative example 11 is of artificial graphite MCF (a material equivalent to a carbon anode used for current Li secondary batteries).

TABLE 5

| | Sample[mg] | Current value[μA] |
|---|---|---|
| Comparative example 11 | 3.1 | 100 |
| Example 12 | 4.2 | 100 |
| Example 13 | 5.8 | 100 |

Voltage: 0.02-1.5 V

### [3. Results]

### [3.1. Powder Composition]

A composition of the FeSiₓ-Si composite powder was approximately equal to the nominal composition.

### [3.2. Density and Specific Surface Area]

Table 6 shows density and specific surface area of the powder synthesized in each of the Examples 11 to 13. Table 6 additionally shows z (Si/Fe ratio) in ICP analysis value.

Table 6 reveals the following:

(1) Specific surface area decreases with an increase in reaction temperature. This is conceivably because a long reaction at high temperature leads to formation of a larger amount of silicide, and causes melting of the raw materials or agglomeration of the synthesized powder.

(2) Density and specific surface area of the powder are different depending on collecting methods of the powder. This is conceivably because the content of each of the high-density Fe₃Si phase and the low-density Si-nanosheet or Ca-deficient layered Ca-silicide is different depending on magnetic separation ways.

TABLE 6

| | | Specific surface area | Density |
|---|---|---|---|
| | z* | (m²/g) | (g/cm³) |
| Example 11 | 2.04 | 6.9 | 7.18 |
| Example 12 | 2.31 | 45.2 | 3.95 |
| Example 13 | 2.01 | 23.8 | 5.09 |

*z = Si/Fe

### [3.3. X-Ray Diffraction]

### [3.3.1. CaSi_{y}—Si Composite Powder]

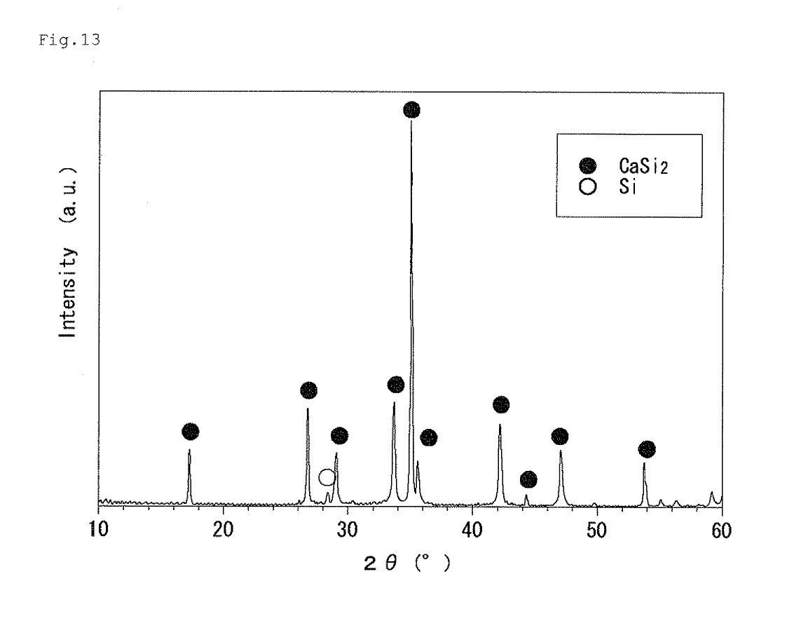

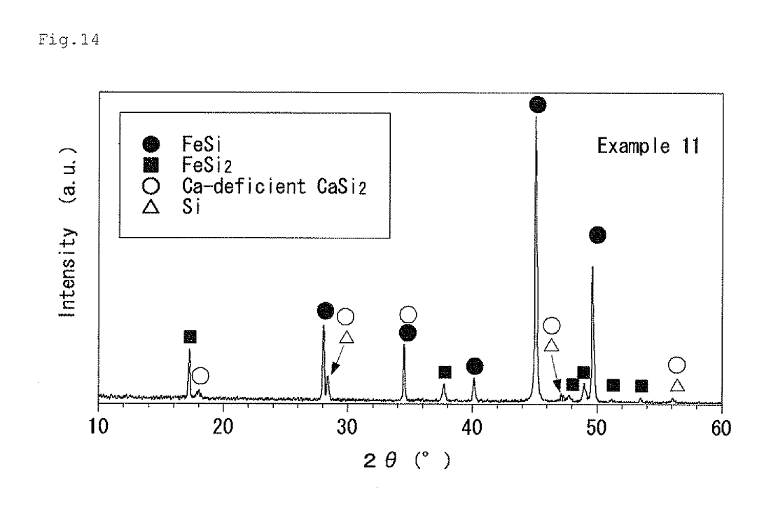

FIG. 13 shows an X Ray diffraction pattern of the CaSi_{y}—Si composite powder synthesized in the Example 11. FIG. 13 reveals that the synthesized powder includes a layered CaSi₂ phase containing a small amount of Si.

### [3.3.2. FeSi—Si Composite Powder]

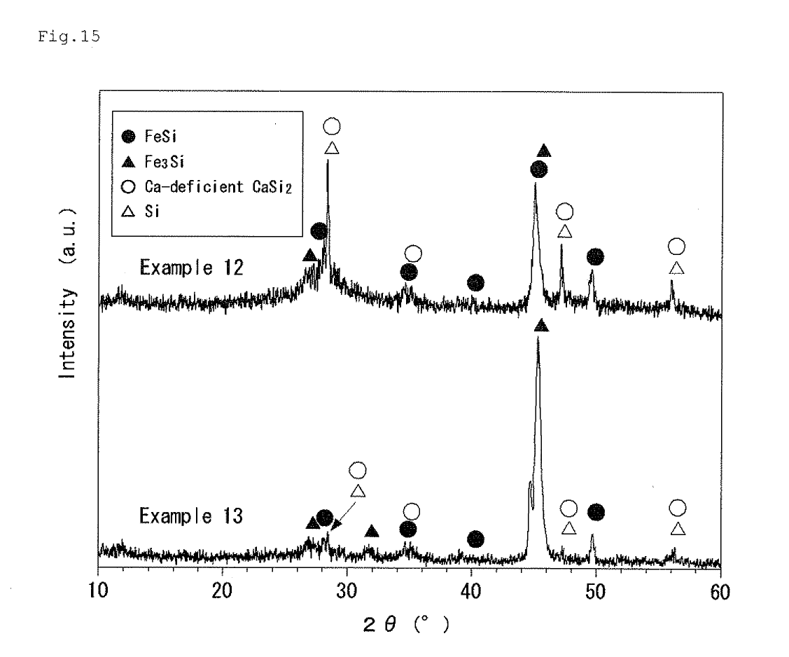

FIGS. 14 and 15 show respective X-Ray diffraction patterns of the FeSi—Si composite powder obtained in the Examples 11 to 13.

The powder obtained in the Example 11 includes a FeSi phase, a FeSi₂ phase, a Si phase, and a Ca-deficient layered Ca-silicide (Ca-deficient CaSi₂) phase. The powder obtained in each of the Examples 12 and 13 includes a FeSi phase, a FeSi phase, a Si phase, and a Ca-deficient layered Ca-silicide (Ca-deficient CaSi₂) phase. The Ca-deficient CaSi₂ is described in detail later.

### [3.4. SEM Observation and TEM Observation]

### [3.4.1. SEM Observation]

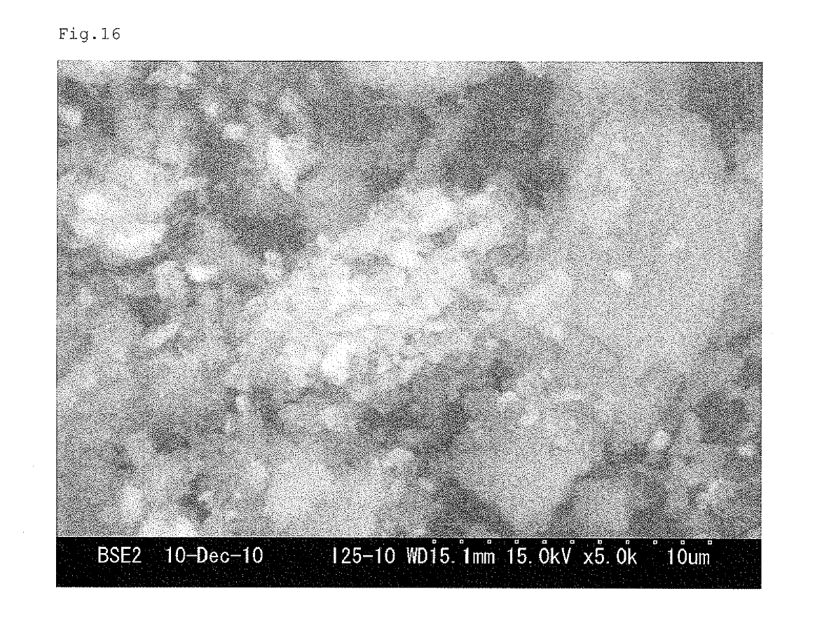

FIG. 16 shows a SEM image of the FeSiₓ-Si composite powder obtained in the Example 12. In the powder obtained in the Example 12, FeSi particles and Fe₃Si particles, having a diameter of approximately 1 μm or less (each portion of a light gray contrast in the SEM image), and particles conceivably including the Si-nanosheet or Ca-deficient layered Ca-silicide (each portion of a dark gray contrast in the SEM image) were observed. EDX analysis revealed that a composition of the latter particles was within a range of Ca/Cl/Si=0 to 0.05/0 to 0.10/2, and different depending on places. In addition, SEM observation revealed existence of a small amount of coarse Si particles having a diameter of several micrometers derived from the raw material.

### [3.4.2. TEM Observation]

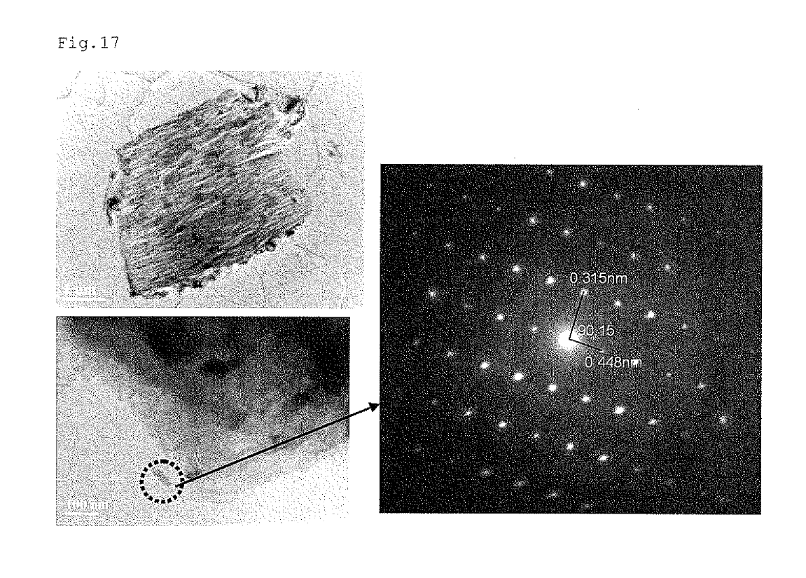

FIG. 17 shows a low-magnification TEM image of the FeSiₓ-Si composite powder obtained in the Example 12 (upper left photograph), a high-magnification TEM image of a region containing the FeSi phase (lower left photograph), and an electron diffraction image of the FeSi phase (right photograph). In the powder obtained in the Example 12, particles conceivably including the Si-nanosheet or Ca-deficient layered Ca-silicide having a diameter of several micrometers (dark gray contrast portion as a base), and particles, tightly compounded with one another, conceivably including FeSi particles or Fe₃Si particles having a diameter of approximately 100 nm or less (black contrast portion) were observed. The FeSi or Fe₃Si particles are likely to lie on the Si-nanosheet or Ca-deficient layered Ca-silicide as the base.

As shown in the right photograph of FIG. 17, FeSi particles showing single-crystal-like, clear electron diffraction were confirmed to exist, suggesting that the composite powder contains FeSi or Fe₃Si particles having high crystallinity.

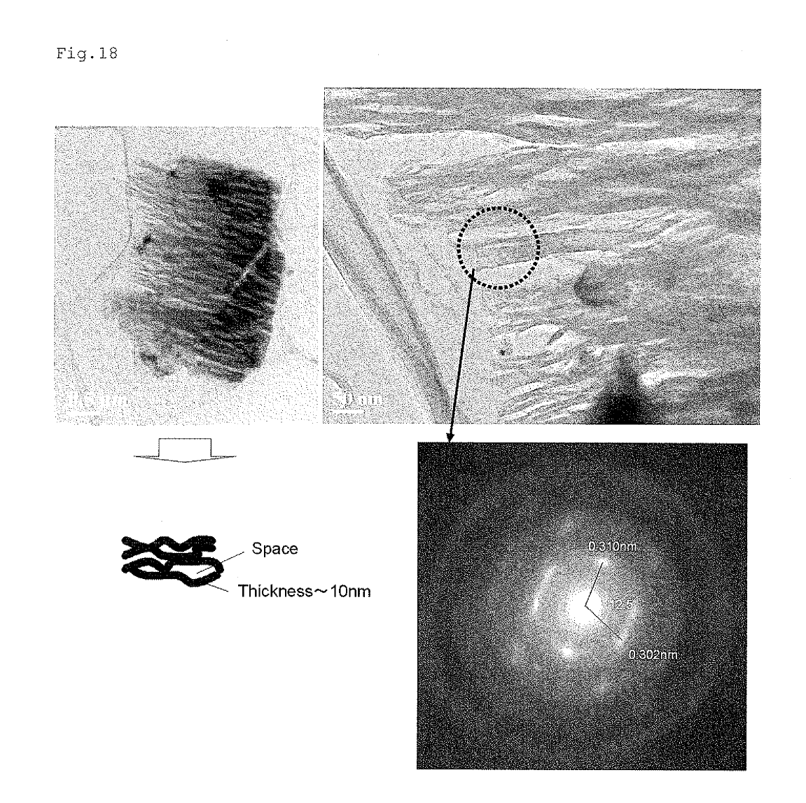

FIG. 18 shows a low-magnification TEM image of a layered substance contained in the FeSiₓ-Si composite powder obtained in the Example 12 (upper left photograph), a high-magnification TEM image thereof (upper right photograph), an electron diffraction image thereof (lower right photograph), and a schematic diagram of the layered substance (lower left diagram). FIG. 18 reveals that the particle considered to be the Si-nanosheet or Ca-deficient layered Ca-silicide has a structure configured of plate-like or sheet-like particles approximately 10 nm thick laminated with spaces.

The electron diffraction image (lower right photograph of FIG. 18) reveals that the plate-like particle has approximately the same structure as the raw material, layered CaSi₂, namely, the plate-like particle includes CaSi₂ from which Ca escapes substantially completely. It is considered that a portion of the CaSi₂ where Ca completely escapes becomes Si. This is obvious even from the XRD and the SEM images suggesting existence of Si and of the Ca-deficient layered Ca-silicide.

When Ca does not completely escape from CaSi₂, Cl conceivably enters interlayer of the layered substance to maintain electrical neutrality. Composition analysis of the layered substance was performed by EDX. As a result, a composition of a portion in a circle in the upper right photograph of FIG. 18 was Ca_{0.03}Cl_{0.06}Si₂.

FIG. 19 shows a TEM image of another layered substance contained in the FeSiₓ-Si composite powder obtained in the Example 12 (left photograph) and an electron diffraction image thereof (right photograph). As shown in FIG. 19, a portion having a structure corresponding to a layered CaSi₂ structure is observed.

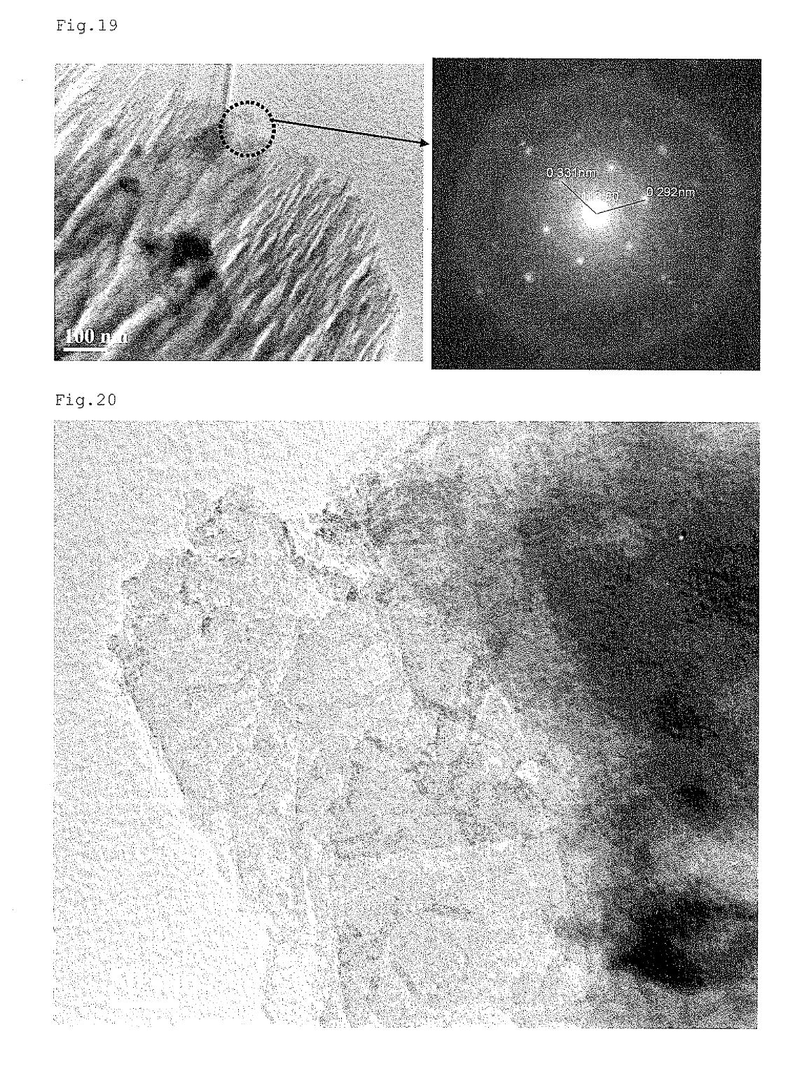

FIG. 20 shows a TEM image of still another layered substance contained in the FeSiₓ-Si composite powder obtained in the Example 12. As shown in FIG. 20, a TEM image regarded as a top view of plate-like or sheet-like particles is observed.

As in the Example 12, a result is obtained in each of the Examples 11 and 13, which suggests that the powder is configured of Fe-silicide particles (FeSi, Fe₃Si, or FeSi₂) having high crytallinity compounded with particles conceivably including the plate-like or sheet-like Si-nanosheet or Ca-deficient layered Ca-silicide.

### [3.4. Charge/Discharge Characteristic]

Table 7 shows charge capacity of the FeSiₓ-Si composite powder. Table 7 additionally shows charge capacity of artificial graphite MCF (Comparative example 11).

Charge capacity is considerably high in each of the Examples 12 and 13 compared with in the Comparative example 11. This is conceivably because while the Fe-silicide particles (FeSi, Fe₃Si, or FeSi₂) hardly react with Li and thus have a low charge capacity, the Si-nanosheet or Ca-deficient layered Ca-silicide in the powder actively reacts with Li and thus have a high charge capacity. As for the Example 11, while charge/discharge capacity is not measured, since the powder contains a considerably large amount of Si as shown in FIG. 14, sufficiently high charge capacity can be expected.

Here, the Si-nanosheet or Ca-deficient layered Ca-silicide has a shape including thin plates or sheets laminated with spaces, each plate or sheet having a thickness of approximately 10 nm. It is estimated that this allows an electrolyte to be easily diffused, leading to high reactivity with Li. In addition, it is considered that since the Si-nanosheet or Ca-silicide is tightly compounded with conductive Fe—Si particles, electrons are adequately transferred to a current collector during charge.

TABLE 7

| | Charge capacitance(mAh/cm³) |
|---|---|
| Comparative example 11 | 424 |
| Example 12 | 2480 |
| Example 13 | 889 |

While the embodiment of the invention has been described in detail hereinbefore, the invention is not limited to the above embodiment, and various modifications or alterations of the invention may be made within a scope without departing from the gist of the invention.

The transition metal silicide-Si composite powder and the method of manufacturing the composite powder according to the invention may be used for an anode material of a Li secondary battery and a method of manufacturing the anode material.

The CaSi_{y}-based powder for manufacturing transition metal silicide-Si composite powder and the method of manufacturing the CaSi_{y}-based powder according to the invention may be used for a raw material for manufacturing the transition metal silicide-Si composite powder according to the invention and a method of manufacturing the raw material.

What is claimed is:

1. A transition metal silicide-Si composite powder:
wherein one or more transition metal elements (M) are contained,
a Si/M ratio (z) satisfies 2.0≦z≦20.0, and
a specific surface area is 2.5 m²/g or more.

2. The transition metal silicide-Si composite powder according to claim 1, including a composite containing transition Metal silicide particles and Si-nanosheet or Ca-deficient layered Ca-silicide.

3. The transition metal silicide-Si composite powder according to claim 2, wherein the Si-nanosheet or Ca-deficient layered Ca-silicide has a composition expressed by CaᵤXᵥSi₂ (0≦u≦0.1, 0≦v≦0.2, and X denotes halogen).

4. The transition metal silicide-Si composite powder according to claim 2, further containing Si particles.

5. The transition metal silicide-Si composite powder according to claim 1, wherein the transition metal element (M) is one or both element selected from a group consisting of Mn and Fe.

6. The transition metal silicide-Si composite powder according to claim 1, wherein the transition metal silicide-Si composite powder is used for an anode material of a Li secondary battery.

7. The transition metal silicide-Si composite powder according to claim 6, wherein charge capacity of Li ions is 500 mAh/cm³ or more.

8. CaSi_{y}-based powder for manufacturing transition metal silicide-Si composite powder:
wherein a Si/Ca ratio (w) satisfies 2.0≦w≦20.0,
at least a Ca-silicide phase is contained, and
when the transition metal element (M) includes Mn only, w=2.0 is excluded.

9. A method of manufacturing CaSi_{y}-based powder for manufacturing transition metal silicide-Si composite powder, comprising:
a melting step of mixing a Ca source with a Si source into a Si/Ca ratio (mole ratio) (w) of 2.0≦w≦20.0, and melting the Ca and Si sources; and
a solidification step of solidifying molten material obtained in the melting step to obtain the CaSi_{y}-based powder for manufacturing transition metal silicide-Si composite powder according to claim 8.

10. The method of manufacturing CaSi_{y}-based powder for manufacturing transition metal silicide-Si composite powder according to claim 9, wherein the solidification step is performed by solidifying the molten material by rapid cooling.

11. A method of manufacturing transition metal silicide-Si composite powder, comprising:
a mixing step of mixing the CaSi_{y}-based powder for manufacturing the transition metal silicide-Si composite powder according to claim 8 with halide of a transition metal element (M);
a reaction step of heating and cooling a mixture obtained in the mixing step; and
a washing step of washing a reaction product obtained in the reaction step by one or more solvents that may dissolve the halide of the transition metal element (M) and/or Ca-halide so as to remove unreacted halide of the transition metal element (M) and the Ca-halide as a by-product.

12. The method of manufacturing transition metal silicide-Si composite powder according to claim 11, wherein in the mixing step, the CaSi_{y}-based powder for manufacturing transition metal silicide-Si composite powder is mixed with the halide of the transition metal element (M) such that a M/Ca ratio (molar ratio) (α) satisfies α≧1.

13. The method of manufacturing transition metal silicide-Si composite powder according to claim 11, wherein in the reaction step, the mixture is heated at a temperature equal to or higher than 30% of a melting point of the halide of the transition metal element (M) and equal to or lower than 98% thereof.
